(19) United States
(12) Patent Application Publication
(10) Pub. No.: US 2015/0001372 A1
(43) Pub. Date: Jan. 1, 2015

(54) POROUS ARTICLES, METHODS, AND APPARATUSES FOR FORMING SAME

(71) Applicant: Saint-Gobain Ceramics & Plastics, Inc., Worcester, MA (US)

(72) Inventors: Satyalakshmi K. Ramesh, Shrewsbury, MA (US); Chuanping Li, Shrewsbury, MA (US); Paul Braun, Providence, RI (US); Michael J. Ferrecchia, Marlborough, MA (US)

(21) Appl. No.: 14/311,745

(22) Filed: Jun. 23, 2014

Related U.S. Application Data
(60) Provisional application No. 61/840,304, filed on Jun. 27, 2013.
(60) Provisional application No. 61/840,320, filed on Jun. 27, 2013.
(60) Provisional application No. 61/840,326, filed on Jun. 27, 2013.

(51) Int. Cl. B29C 33/02

(52) U.S. Cl. CPC B29C 33/02; B29K 2995/0013
USPC 249/111

(57) ABSTRACT

A mold for forming a porous article can include a first material having a first thermal conductivity and a second material having a second thermal conductivity different from the first thermal conductivity. The first material may be at least partially embedded within the second material and configured to create regions of different thermal conductivity in the body, such as configured to create distinct nucleation regions within a material formed within the mold. A method for forming a porous article can include providing a slurry within a mold and freeze-casting the slurry to form a ceramic article having a burst-like distribution of porosity. A porous article according to embodiments herein can include a burst-like distribution of porosity.

### CROSS-REFERENCE TO RELATED APPLICATION

This application claims priority to U.S. Provisional Patent Application No. 61/840,304, entitled “Porous Articles, Methods, and Apparatuses for Forming Same,” naming inventors Satyalakshmi K. Ramesh et al., filed Jun. 27, 2013, and U.S. Provisional Patent Application No. 61/840,320, entitled “Porous Articles, Methods, and Apparatuses for Forming Same,” naming inventors Satyalakshmi K. Ramesh et al., filed Jun. 27, 2013, and U.S. Provisional Patent Application No. 61/840,326, entitled “Porous Articles, Methods, and Apparatuses for Forming Same,” naming inventors Satyalakshmi K. Ramesh et al., filed Jun. 27, 2013, which applications are incorporated by reference herein in their entireties.

### FIELD OF THE DISCLOSURE

The following is directed to porous articles, and particularly, porous articles, methods and apparatuses for forming porous articles.

### DESCRIPTION OF THE RELATED ART

Porous articles are used in a variety of industries for a variety of uses. For example, porous articles, such as traditional porous ceramic articles, can include whitewares, stonewares, and the like, and may be used in a variety of places and applications, including for example, serving utensils, houseware tools, containers (e.g., pots), insulators, plumbing materials and appliances, abrasives, and the like. Moreover, porous articles are deployed in more high tech or advanced industries, including but not limited to, aerospace, medical devices, fuel cells, and the like.

Porous articles can have various external forms or shapes, such as that of plates, bricks, bowls, and can include various flat or curved surfaces. Furthermore, the internal morphology of porous articles can be made to be nearly fully dense or may be made to be porous, such as including porosity or porosity channels.

Various traditional methods have been employed to form porous articles, such as, for example, drilling holes in the porous article. Other traditional methods may also include forming a porous article with a mixture of differently sized particles that create a vacancy between the particles or grains of particles.

There remains a need in the industry for improving the porosity of porous articles.

### SUMMARY

According to a first aspect, a mold for forming a porous article includes a body having a planar surface, a first material having a first thermal conductivity, wherein the first material forms a first portion of the planar surface; and a second material having a second thermal conductivity different from the first thermal conductivity, the second material forming a second portion of the planar surface distinct from the first portion.

In yet another aspect, a mold for forming a porous article includes a body comprising a plurality of discrete first regions spaced apart from each other, the plurality of discrete first regions comprising a first material, wherein the plurality of first regions are arranged in a predetermined distribution relative to each other.

For another aspect, a mold for forming a porous article includes a body having a surface, the surface comprising a first material having a first thermal conductivity, wherein the first material forms a first portion of the planar surface; and a second material having a second thermal conductivity different from the first thermal conductivity.

According to one aspect, a mold for forming a porous article includes a body having a thickness; a first material having a first thermal conductivity, wherein the first material extends through a portion of the thickness; and a second material having a second thermal conductivity different from the first thermal conductivity, the second material forming a second portion of the thickness distinct from the first portion.

For still another aspect, a mold for forming a porous article includes a body comprising a first material; a second material at least partially embedded within the first material and configured to create regions of different thermal conductivity in the body.

In a certain aspect, a mold for creating a porous article includes a body comprising a layer; at least one object extending at least partially through the layer of the body and configured to form a first distinct nucleation region within a material formed within the mold.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The present disclosure may be better understood, and its numerous features and advantages made apparent to those skilled in the art by referencing the accompanying drawings.

FIG. 1 includes a side cross-sectional illustration of a portion of a mold for forming a porous article in accordance with an embodiment.

FIG. 2 includes a side cross-sectional illustration of a portion of a mold for forming a porous article in accordance with an embodiment.

FIG. 3 includes a side cross-sectional illustration of a portion of a mold for forming a porous article in accordance with an embodiment.

FIG. 4 includes a perspective image of a portion of a mold for forming a porous article in accordance with an embodiment.

FIG. 5 includes a perspective image of a portion of a mold for forming a porous article in accordance with an embodiment.

FIG. 6 includes a top or bottom planar illustration of a portion of a porous article formed in accordance with an embodiment.

FIG. 7 includes a side cross-sectional illustration of a portion of a porous article in accordance with an embodiment.

FIG. 8 includes a side cross-sectional illustration of a portion of a porous article in accordance with an embodiment.

FIG. 9 includes a side cross-sectional illustration of a portion of a porous article in accordance with an embodiment.

FIG. 10 includes a bottom planar image of a portion of a porous article in accordance with an embodiment.

FIG. 11 includes a top planar image of a portion of a porous article in accordance with an embodiment.

FIG. 12 includes a side cross-sectional image of a portion of a porous article in accordance with an embodiment.

FIG. 12a includes an image of a bottom planar view of a portion of a porous article in accordance with an embodiment.

FIG. 12b includes an image of a bottom planar view of a portion of a porous article in accordance with an embodiment.

FIG. 13 includes a side frontal illustration of a portion of a porous article in accordance with an embodiment.

### DETAILED DESCRIPTION

The following is directed to apparatuses for making porous articles and porous articles made from such apparatuses, which may be useful in a variety of places and applications, including, for example, serving utensils, housewares, containers (e.g., pots), insulators, plumbing materials and appliances, abrasives, and the like. Moreover, apparatuses for making porous articles and porous articles made from such apparatuses are useful in more high tech or advanced industries, including, but not limited to, vehicles used for transportation, temperature modifying systems, aerospace, edifices, electronic devices, communication devices, “celluar” devices, construction, optics, optoelectronic devices, medical devices, renewable energy devices, fuel cell technologies, and the like, and may be deployed in such articles as filters, gas separation membranes, catalyst supports, radiant burners, prosthetic devices, scaffolds, tissue engineering, acoustic insulators, building materials, and the like. In particular, apparatuses for making porous articles and porous articles made from such apparatuses are useful for making fuel cell articles, such as solid oxide fuel cell (SOFC) articles and ceramic gas separation membranes.

### Apparatuses for Forming Porous Articles

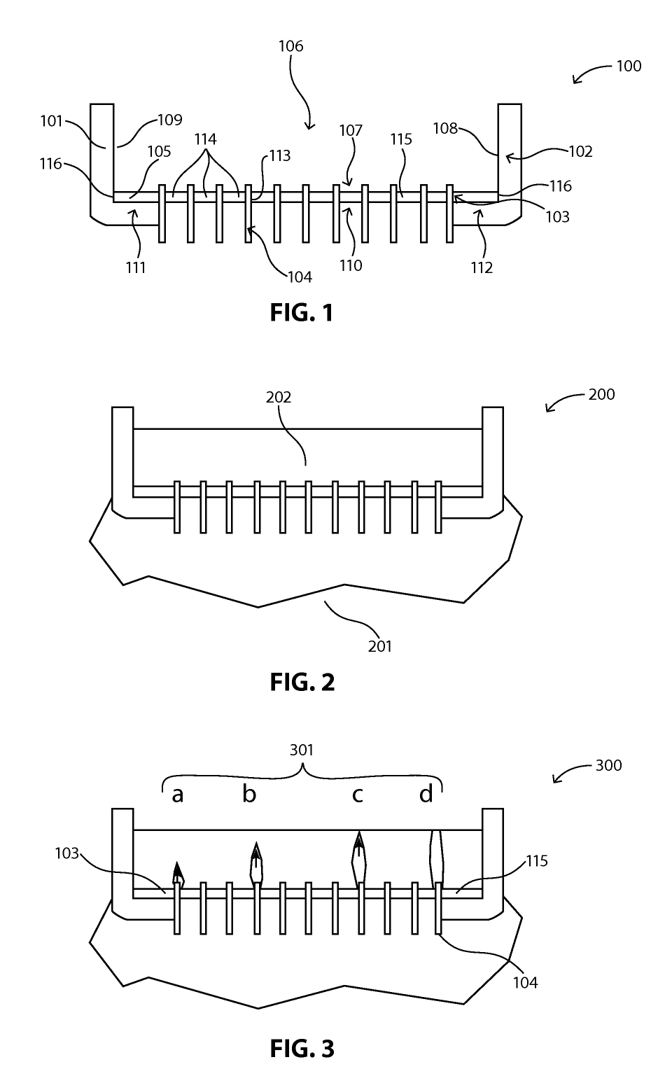

FIG. 1 includes a sectional view illustration of a mold 100 in accordance with an embodiment. The mold 100 may include a base plate 103, a first lateral member 101, and a second lateral member 102. In an embodiment, the first lateral member 101 can be configured to support the base plate 103 at a first end 111 of the base plate 103 and the second lateral member 102 can be configured to support the base plate 103 at a second end 112 of the base plate 103.

In another embodiment, the base plate 103 may include one or more ends 111 and 112, which can be defined by one or more edge portion(s) 116 of the base plate 103. The one or more edge portion(s) 116 may be arranged with respect to each other to provide a two-dimensional shape to the base plate 103. Moreover, the shape of the base plate 103 may in part define the number and shape of one or more lateral members (e.g. 101 and 102, as particularly illustrated in FIG. 1). For example, the base plate 103 may include a shape that is polygonal, circular, ellipsoid, or a combination thereof. In the case of a polygonal-shaped base plate, the base plate 103 may have two or more ends defined by a straight edges, and may be supported by one or more lateral members on each end 111 and 112. For example, the base plate 103 may be supported by the first lateral members 101 on end 111, and the second lateral member 102 on end 112. In the certain instance of an ellipsoid-shaped base plate, the base plate 103 may have two or more ends defined by either straight or curved edges, and may be supported by the one or more lateral members on each end. In the instance of a circular-shaped base plate, the base plate 103 may have one or more ends defined by a continuous circular edge, and may be supported by one or more lateral members on the continuous circular edge of the base plate. In one instance, the base plate 103 may not include one or more edge portion(s) 116. For example, the base plate may include a tape-cast surface without any particularly discernible edge portions. In an embodiment, the one or more lateral member(s) may conform to the shape of the base plate 103. In particular instances, the one or more lateral member(s) may conform to the shape of the ends 111 and 112 or edges 116 of the base plate 103. In either instance, it is considered within the scope of the present invention that one or more lateral members may support the base plate 103 at any position along an edge of the base plate 103.

In accordance with an embodiment, although not shown in the FIGS., the mold 100 may include a base plate 103 that may include the shape of a container. For example, the base plate 103 may include one or more surfaces, and in particular, one or more lateral sides. In certain instances, the base plate 103 may be in the shape of a container, such as, for example, a box, a cup, a cylinder, a tube, or a combination thereof, that may support or contain a slurry provided therein. In particular instances, the base plate 103 may include one or more discrete nucleation regions or sites distributed on the one or more surfaces or lateral sides.

In another embodiment, the one or more lateral members (e.g. 101, 102) may be integral with each other, connected with each other, or combined into a single structure. In a particular embodiment, the mold may include a single lateral member that is configured to support the base plate 103 on all sides or edge(s) of the base plate 103, such as in the instance of a circular base plate. In another embodiment, the base plate 103 may be generally integral with the mold 100. For example, the base plate 103 may be integral with the one or more lateral members, such as the first and second lateral members 101, 102.

The one or more lateral members (e.g. 101, 102) may be configured to support the base plate 103 by being attached to the base plate 103. For example, the one or more lateral members (e.g. 101, 102) may be attached to the base plate 103 by gravity, friction, bond material (e.g., adhesive), a structural fitting such as a fastener, which may include for example, a nail, a screw, a hook and loop, an interference fit connection, or any combination thereof.

In accordance with an embodiment, the mold 100 may include an interior surface 106. The interior surface 106 may be defined in part by the planar surface 107 of the base plate 103, a first interior lateral surface 109 of the first lateral member 101, and a second interior lateral surface 108 of the second lateral member 102. Although FIG. 1 illustrates a planar surface 107, it will be appreciated that the base plate 103 of the mold 100 can include a surface that may be any shape including, for example, a curved surface. In an embodiment, the first interior lateral surface 109 and/or the second interior lateral surface 108 may be located at or near the edge(s) 116 of the base plate 103. In an embodiment, the first interior lateral surface 109 and/or the second interior lateral surface 108 may be perpendicular with respect to the planar surface 107 of the base plate 103. In an embodiment, the one or more lateral members (e.g. 101 and 102) may be perpendicular to the planar surface 107 of the base plate 103. In an embodiment, the one or more lateral members (e.g. 101 and 102) may be parallel with respect to each other. However, it is considered within the scope of the embodiments disclosed herein that the first and second interior lateral surfaces 109 and 108 may arranged in any angle with respect to the planar surface 107 and with respect to each other. In a particular embodiment, the mold 100 can be adapted to receive material, such as a slurry, in the interior surface 106 of the mold 100.

In an embodiment, the base plate 103 can include a planar surface 107 and a thickness 105. In an embodiment, the thickness 105 may be defined at least in part as a dimension that extends perpendicularly to the plane of the planar surface 107. In an embodiment, the thickness 105 may also be defined at least in part by the exterior surface 110 of the base plate 103. In an embodiment, the thickness 105 may be defined by a distance between the planar surface 107 and the exterior surface 110. In an embodiment, the thickness of the base plate 103 may be not greater than about 50 mm, such as not greater than about 45 mm, not greater than about 40 mm, not greater than about 35 mm, not greater than about 30 mm, not greater than about 25 mm, not greater than about 20 mm, not greater than about 15 mm, not greater than about 10 mm, not greater than about 9 mm, not greater than about 8 mm, not greater than about 7 mm, not greater than about 6 mm, not greater than about 5 mm, not greater than about 4 mm, not greater than about 3 mm, not greater than about 2 mm, or even not greater than about 1 mm. Still, in another non-limiting embodiment, the thickness of the base plate 103 can be at least about 0 mm, such as at least about 1 mm, at least about 2 mm, at least about 3 mm, at least about 4 mm, at least about 5 mm, at least about 6 mm, at least about 7 mm, at least about 8 mm, at least about 9 mm, at least about 10 mm, at least about 15 mm, at least about 20 mm, at least about 25 mm, at least about 30 mm, at least about 35 mm, at least about 40 mm, or even at least about 45 mm.

In accordance with an embodiment, the base plate 103 may include a first material 104 and a second material 115. In an embodiment, the first material 104 may extend at least partially through the base plate 103. For example, the first material 104 may extend through a first portion 113 of the base plate 103. In an embodiment, the first material may extend through a first portion 113 of the thickness 105 of the base plate 103. For example, in a particular embodiment as shown in FIG. 1, the first material 104 may extend at least partially through a first portion 113 of the thickness 105 of the base plate 103, and through the planar surface 107 of the base plate 103. In another particular embodiment, as shown in FIG. 1, the first material 104 may extend into the interior surface 106 of the mold 100. In yet another embodiment, the first material 104 may extend through a portion of the exterior surface 110 of the base plate 103. As also shown in the particular embodiment of FIG. 1, the first material 104 may extend through a portion of the exterior surface 110 of the base plate 103 and through a portion of the interior surface 106 of the mold 100 such that an end of the first material 104 extends, or terminates, above the planar surface 107. In still another embodiment, although not shown, the first material 104 may be coplanar with the planar surface 107 of the base plate 103 such that an end of the first material 104 terminates at the planar surface 107. It will be appreciated that an end of the first material 104 may be positioned, or terminate, at any point within the thickness 105 of the base plate 103, at the planar surface 107, or within the interior surface 106 of the mold 100.

In an embodiment, the second material 115 may form a second portion 114 of the base plate distinct from the first portion. In a particular instance, the second material 115 may form a second portion 114 of the thickness 105 of the base plate 103 distinct from the first portion 113. For example, as shown in FIG. 1, the first material 104 can form a first portion 113 of the thickness 105 of the base plate 103, and the second material 115 can form a second portion 114 of the thickness 105 of the base plate 103 that is distinct from first portion 113.

In an embodiment, a first material 104 may be in the form of one or more rods, electrodes, wires, or the like. It will be appreciated that the first material 104 can take any variety of shapes, or a combination of shapes.

In an embodiment, the base plate includes a first material that may be at least partially embedded within a second material. In an embodiment, a plurality of thermally conductive objects included in the base plate may be defined by a first material. In a particular embodiment, as shown in FIG. 1, first material 104 may be at least partially embedded within the second material 115. More particularly, as shown in FIG. 1, a portion of the first material 104 may be surrounded by the second material 115. In an embodiment, the portion of the first material 104 that may be surrounded by the second material 115 can be a portion of the length of the first material 104. In another embodiment, the first material 104 may by fully encapsulated by the second material 115. In anther embodiment, at least two (2) surfaces of the first material 104 may be surrounded or contacted by the second material 115. In yet another embodiment, a portion of the length, width, and/or height of the first material 104 may be contacted by the second material 115. In a particular embodiment, as shown in FIG. 4, the base plate 400 includes a first material 404 that can be partially embedded within a second material 402.

Suitable materials for the first material may include a thermal conductor or a thermal insulator. In one embodiment, the first material 104 can be a thermal conductor and the second material 115 can be a thermal insulator. In particular, the first material 104 may comprise an inorganic material, a metallic material, a transition metal, copper, or any combination thereof. In a particular embodiment, the first material 104 comprises copper. However, it will be appreciated that the plurality of thermally conductive objects that may be defined by a first material may include different first materials with respect to each other. For example, one thermally conductive object may include a first material 104 that include copper, while another thermally conductive object may include a first material 104 that includes a material different than copper.

Suitable materials for the second material 115 may include a thermal conductor or a thermal insulator. In an embodiment, the second material 115 may comprise an organic material, a polymer, an epoxy, a resin, an inorganic material, a metallic material, a ceramic material, a vitreous material, or any combination thereof. In a particular embodiment, the second material comprises a ceramic material.

In accordance with an embodiment, the first portion 113 (including the first material) may define a first volume (VT₁) of the thickness of the base plate, and the second portion 114 (including the second material) may define a second volume (VT₂) of the thickness of the base plate that can be different than the first volume of the thickness of the base plate. In an embodiment, the second volume can be different than the first volume by at least about 1%, as measured by the equation [(VT₁−VT₂)/VT₁]×100%. It will be appreciated that the percent difference in the volume of the thickness can be measured as the absolute value of the equation noted herein. In certain instances, the second volume can be different than the first volume by at least about 2%, such as at least about 3%, at least about 4%, at least about 5%, at least about 6%, at least about 7%, at least about 8%, at least about 9%, at least about 10%, at least about 12%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 98%, or even at least about 99%. It will be appreciated that the difference in volume between the second volume and the first volume can be within a range between any of the minimum and maximum percentages noted above.

In a particular embodiment, the second volume can be less than the first volume by at least about 1%, as measured by the equation [(VT₁−VT₂)/VT₁]×100%. It will be appreciated that the percent difference in the volume of the thickness can be measured as the absolute value of the equation noted herein. In certain instances, the second volume can be less than the first volume by at least about 2%, such as at least about 3%, at least about 4%, at least about 5%, at least about 6%, at least about 7%, at least about 8%, at least about 9%, at least about 10%, at least about 12%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 98%, or even at least about 99%. In accordance with another embodiment, the second volume can be less than the first volume by not greater than about 1%, such as not greater than about 2%, not greater than about 3%, not greater than about 4%, not greater than about 5%, not greater than about 6%, not greater than about 7%, not greater than about 8%, not greater than about 9%, not greater than about 10%, not greater than about 12%, not greater than about 15%, not greater than about 20%, not greater than about 25%, not greater than about 30%, not greater than about 35%, not greater than about 40%, not greater than about 45%, not greater than about 50%, not greater than about 55%, not greater than about 60%, not greater than about 65%, not greater than about 70%, not greater than about 75%, not greater than about 80%, not greater than about 85%, not greater than about 90%, not greater than about 95%, not greater than about 98%, or even not greater than about 99%. It will be appreciated that the difference in volume between the second volume and the first volume can be within a range between any of the minimum and maximum percentages noted above.

In another embodiment, the first volume can be less than the second volume by at least about 1%, as measured by the equation [(VT₂−VT₁)/VT₂]×100%. It will be appreciated that the percent difference in the volume of the thickness can be measured as the absolute value of the equation noted herein. In certain instances, the first volume can be less than the second volume by at least about 2%, such as at least about 3%, at least about 4%, at least about 5%, at least about 6%, at least about 7%, at least about 8%, at least about 9%, at least about 10%, at least about 12%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 98%, or even at least about 99%. In accordance with another non-limiting embodiment, the first volume can be less than the second volume by not greater than about 1%, such as not greater than about 2%, not greater than about 3%, not greater than about 4%, not greater than about 5%, not greater than about 6%, not greater than about 7%, not greater than about 8%, not greater than about 9%, not greater than about 10%, not greater than about 12%, not greater than about 15%, not greater than about 20%, not greater than about 25%, not greater than about 30%, not greater than about 35%, not greater than about 40%, not greater than about 45%, not greater than about 50%, not greater than about 55%, not greater than about 60%, not greater than about 65%, not greater than about 70%, not greater than about 75%, not greater than about 80%, not greater than about 85%, not greater than about 90%, not greater than about 95%, not greater than about 98%, or even not greater than about 99%. It will be appreciated that the difference in volume between the second volume and the first volume can be within a range between any of the minimum and maximum percentages noted above.

In accordance with an embodiment, the mold 100 may include a first material (MAT_{T}) and an entire surface area of the interior surface (ESAᵢ) of the mold 100. In an embodiment, the first material may occupy less than the entire surface area of the interior surface of the mold, as measured by the equation [(ESAᵢ−MAT₁/ESAᵢ]×100%. It will be appreciated that the percent difference first material and the entire surface area of the interior surface of the mold can be measured as the absolute value of the equation noted herein. In a particular embodiment, the first material may occupy at least about 1% of the entire surface area of the interior surface of the mold, such as at least about 2%, at least about 3%, at least about 4%, at least about 5%, at least about 6%, at least about 7%, at least about 8%, at least about 9%, at least about 10%, at least about 12%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 98%, or even at least about 99%. In accordance with another embodiment, the first material may occupy not greater than about 1% of the entire surface area of the interior surface of the mold, such as not greater than about 2%, not greater than about 3%, not greater than about 4%, not greater than about 5%, not greater than about 6%, not greater than about 7%, not greater than about 8%, not greater than about 9%, not greater than about 10%, not greater than about 12%, not greater than about 15%, not greater than about 20%, not greater than about 25%, not greater than about 30%, not greater than about 35%, not greater than about 40%, not greater than about 45%, not greater than about 50%, not greater than about 55%, not greater than about 60%, not greater than about 65%, not greater than about 70%, not greater than about 75%, not greater than about 80%, not greater than about 85%, not greater than about 90%, not greater than about 95%, not greater than about 98%, or even not greater than about 99%. It will be appreciated that the first material may occupy a percentage of the entire surface area of the interior surface of the mold within a range between any of the minimum and maximum percentages noted above.

In accordance with an embodiment, the base plate 103 may include an entire surface area of the planar surface (ESAₚₛ) of the base plate 103. In an embodiment, the first material may occupy less than the entire surface area of the interior surface of the mold, as measured by the equation [(ESAₚₛ−MAT₁/ESAₚₛ]×100%. It will be appreciated that the percent difference first material and the entire surface area of the planar surface of the base plate can be measured as the absolute value of the equation noted herein. In a particular embodiment, the first material may occupy at least about 1% of the entire surface area of the planar surface of the base plate, such as at least about 2%, at least about 3%, at least about 4%, at least about 5%, at least about 6%, at least about 7%, at least about 8%, at least about 9%, at least about 10%, at least about 12%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 98%, or even at least about 99%. In accordance with another embodiment, the first material may occupy not greater than about 1% of the entire surface area of the planar surface of the base plate, such as not greater than about 2%, not greater than about 3%, not greater than about 4%, not greater than about 5%, not greater than about 6%, not greater than about 7%, not greater than about 8%, not greater than about 9%, not greater than about 10%, not greater than about 12%, not greater than about 15%, not greater than about 20%, not greater than about 25%, not greater than about 30%, not greater than about 35%, not greater than about 40%, not greater than about 45%, not greater than about 50%, not greater than about 55%, not greater than about 60%, not greater than about 65%, not greater than about 70%, not greater than about 75%, not greater than about 80%, not greater than about 85%, not greater than about 90%, not greater than about 95%, not greater than about 98%, or even not greater than about 99%. It will be appreciated that the first material may occupy a percentage of the entire surface area of the planar surface of the base plate within a range between any of the minimum and maximum percentages noted above.

In an embodiment, the base plate 103 can include a plurality of first discrete regions 301. As illustrated in the particular embodiment of FIG. 3, the first material 104 may occupy the plurality of first discrete regions 301 of the mold 300. In a particular embodiment, the plurality of first discrete regions 301 can be at least in part defined by a portion of the first material 104. In an embodiment, the plurality of first discrete regions 301 may consist essentially of the first material 104. The plurality of first discrete regions 301 may be regions at or near the planar surface 107 of the base plate 103 that faces the interior surface 106 of the mold 100. In another embodiment, the plurality of first discrete regions 301 are regions within the thickness 105 of the base plate 103, such that a portion of the thickness 105 of the base plate 103 includes a plurality of first discrete regions 301.

In an embodiment, the plurality of first discrete regions 301 may be spaced apart from each other. For example, in certain instances, the plurality of first discrete regions 301 may be detached from each other as viewed normal (perpendicularly) to a first plane that intersects the plurality of first discrete regions 301. In an embodiment, the plurality of first discrete regions 301 may be individually separate and distinct from each other. In a particular embodiment, the first plane that intersects the plurality of first discrete regions 301 can be normal (perpendicular) to the direction of the thickness 105 of the base plate 103.

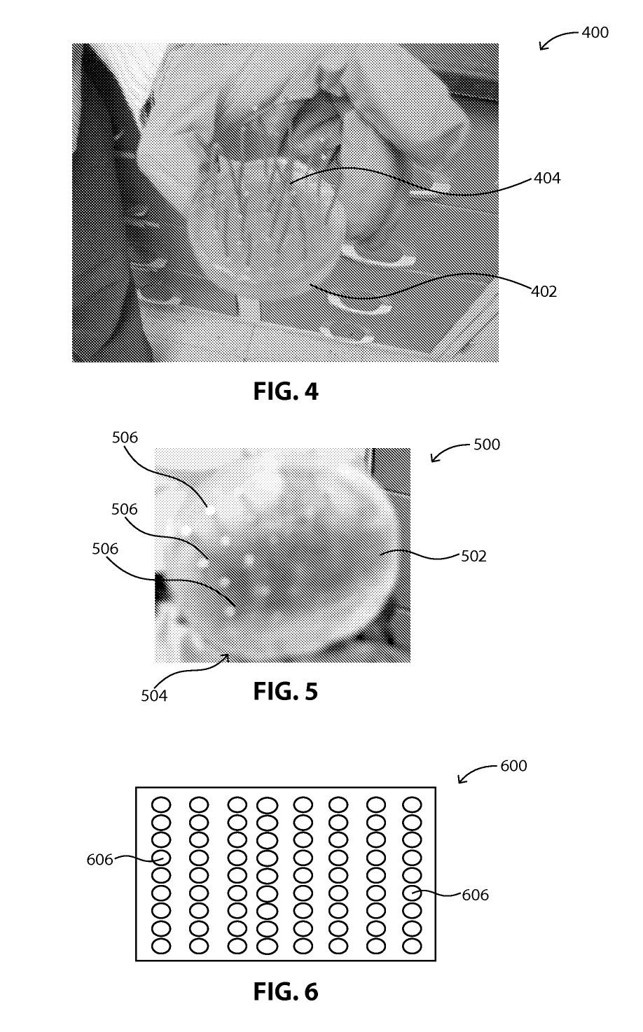

In an embodiment, the plurality of first discrete regions 301 may be arranged in a predetermined distribution relative to each other. FIG. 5 shows a circular base plate 500 with a plurality of first discrete regions 506 including a first material 504 (e.g. copper rods) arranged in a predetermined distribution relative to each other within the second material 502. FIG. 6 shows another embodiment of a rectangular base plate 600 including a predetermined distribution of the first discrete regions 606.

It will be appreciated that a predetermined distribution of first discrete regions can be defined by a combination of predetermined positions on a base plate that are purposefully selected. A predetermined distribution can include a pattern, such that the predetermined positions can define a two-dimensional array. An array can include have short range order defined by a unit of first discrete regions. An array may also be a pattern, having long range order including regular and repetitive units linked together, such that the arrangement may be symmetrical and/or predictable. An array may have an order that can be predicted by a mathematical formula. It will be appreciated that two-dimensional arrays can be formed in the shape of polygons, ellipsis, ornamental indicia, product indicia, or other designs. A predetermined distribution can also include a controlled, non-uniform distribution, a controlled uniform distribution, and a combination thereof. In particular instances, a predetermined distribution may include a radial pattern, a spiral pattern, a phyllotactic pattern, an asymmetric pattern, a self-avoiding random distribution, a self-avoiding random distribution and a combination thereof. The predetermined distribution can be partially, substantially, or fully asymmetric. As used herein, “a phyllotactic pattern” means a pattern related to phyllotaxis. Phyllotaxis is the arrangement of lateral organs such as leaves, flowers, scales, florets, and seeds in many kinds of plants. Many phyllotactic patterns are marked by the naturally occurring phenomenon of conspicuous patterns having arcs, spirals, and whorls. The pattern of seeds in the head of a sunflower is an example of this phenomenon. In particular embodiments, the plurality of first discrete regions may be arranged in a row, a column, a circle, a square, a rectangle, or any combination thereof.

In an embodiment, the first and second materials may be configured to create regions of different thermal conductivity in the base plate, which may facilitate the formation of a porous article according to an embodiment. The base plate may include a first material having a first thermal conductivity (TC₁) and a second material having a second thermal conductivity (TC₂) different from the first thermal conductivity. For example, referring back to FIG. 3, the first material 104 and the second material 115 may be configured to create regions of different thermal conductivity in the base plate 103. As discussed above, the first material 104 may be a thermal conductor or a thermal insulator and the second material 115 may also either be a thermal conductor or a thermal insulator. In a particular embodiment, the first material 104 can include copper and the second material can include a polymer material. It will be appreciated that second thermal conductivity may include a thermal conductivity of a totally thermal insulator. Moreover, it will be appreciated that the first thermal conductivity may include a thermal conductivity of a super thermal conductor.

In accordance with an embodiment, the first material 104 may include a first thermal conductivity, and the second material 115 may include a second thermal conductivity. In either case of material(s) selected for the first material and the second material, it may be preferable that thermal conductivities of the first material and second material be chosen to be different. In an embodiment, the first thermal conductivity may be different than the second thermal conductivity. Thermal conductivity can be measured, for example, by a steady-state or non-steady-state (transient) methods known in the art. For example, thermal conductivity can be measured according to ASTM standards, such as ASTM E1225-09, ASTM D5930-09, and ASTM E1952-11. Thermal conductivity of a material may be measured in watts per meter kelvin (W·m⁻¹·K⁻¹), having a typical unit of measurement k, and is a function of temperature. Furthermore, thermal conductivity of a material may be measured at about 25° C.

In accordance with an embodiment, the first thermal conductivity (TC₁) may be different than the second thermal conductivity (TC₂). In certain instances, the second thermal conductivity may be less than the first thermal conductivity, as measured by the equation [(TC₁−TC₂)/TC₁]×100%. It will be appreciated that the percent difference in thermal conductivity can be measured as the absolute value of the equation noted herein. For example, the second thermal conductivity may be less than the first thermal conductivity by at least about 1%, such as at least about 2%, at least about 3%, at least about 4%, at least about 5%, at least about 6%, at least about 7%, at least about 8%, at least about 9%, at least about 10%, at least about 12%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 98%, or even at least about 99%. In accordance with another embodiment, the second thermal conductivity can be less than the first thermal conductivity by not greater than about 1%, such as not greater than about 2%, not greater than about 3%, not greater than about 4%, not greater than about 5%, not greater than about 6%, not greater than about 7%, not greater than about 8%, not greater than about 9%, not greater than about 10%, not greater than about 12%, not greater than about 15%, not greater than about 20%, not greater than about 25%, not greater than about 30%, not greater than about 35%, not greater than about 40%, not greater than about 45%, not greater than about 50%, not greater than about 55%, not greater than about 60%, not greater than about 65%, not greater than about 70%, not greater than about 75%, not greater than about 80%, not greater than about 85%, not greater than about 90%, not greater than about 95%, not greater than about 98%, or even not greater than about 99%. It will be appreciated that the percent difference in thermal conductivity can be within a range between any of the minimum and maximum percentages noted above.

In still another embodiment, the first thermal conductivity (TC₁) may be less than the second thermal conductivity (TC₂), as measured by the equation [(TC₂−TC₁)/TC₂]×100%. It will be appreciated that the percent difference in thermal conductivity can be measured as the absolute value of the equation noted herein. For example, the first thermal conductivity may be less than the second thermal conductivity by at least about 1%, such as at least about 2%, at least about 3%, at least about 4%, at least about 5%, at least about 6%, at least about 7%, at least about 8%, at least about 9%, at least about 10%, at least about 12%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 98%, or even at least about 99%. In yet another embodiment, the first thermal conductivity can be less than the second thermal conductivity by not greater than about 1%, such as not greater than about 2%, not greater than about 3%, not greater than about 4%, not greater than about 5%, not greater than about 6%, not greater than about 7%, not greater than about 8%, not greater than about 9%, not greater than about 10%, not greater than about 12%, not greater than about 15%, not greater than about 20%, not greater than about 25%, not greater than about 30%, not greater than about 35%, not greater than about 40%, not greater than about 45%, not greater than about 50%, not greater than about 55%, not greater than about 60%, not greater than about 65%, not greater than about 70%, not greater than about 75%, not greater than about 80%, not greater than about 85%, not greater than about 90%, not greater than about 95%, not greater than about 98%, or even not greater than about 99%. It will be appreciated that the percent difference in thermal conductivity can be within a range between any of the minimum and maximum percentages noted above.

In an embodiment, the first thermal conductivity at about 25° C. may be at least about 50 k, at least about 100 k, at least about 200 k, at least about 300 k, at least about 397 k, at least about 400 k. In another non-limiting embodiment, the first thermal conductivity may be not greater than about 1,000 k, such as not greater than 900 k, not greater than about 800 k, not greater than about 700 k, not greater than about 600 k, not greater than about 500 k, not greater than about 450 k. In a certain instance, the first thermal conductivity may be defined by the thermal conductivity of a material at a temperature of about the boiling temperature of liquid nitrogen at standard pressure, which is about −196° C. In a particular instance, the thermal conductivity of the first thermal conductivity at about −196° C. may be at least about 500 k, such as at least about 525 k, or even at least about 550 k. In a non-limiting embodiment, the thermal conductivity of the first thermal conductivity may be less than about 600 k, such as less than about 575 k, or even less than about 550 k. It will be appreciated that the thermal conductivity of the first thermal conductivity may be in a range between any of the maximum or minimum values indicated above.

In an embodiment, the thermal conductivity at about 25° C. of the second thermal conductivity may be less than about 50 k, such as less than about 40 k, less than about 30 k, less than about 20 k, less than about 10 k, less than about 8 k, less than about 6 k, less than about 4 k, less than about 2 k, less than about 1.8 k, less than about 1.5 k, less than about 1.3 k, less than about 1 k, less than about 0.8 k, less than about 0.5 k, less than about 0.3 k, less than about 0.2 k. In an embodiment, the thermal conductivity at about 25° C. of the second thermal conductivity may be greater than about 0.1 k, greater than about 0.3 k, greater than about 0.5 k, greater than about 0.8 k, greater than about 1 k, greater than about 1.3 k, greater than about 1.5 k, greater than about 1.8 k. In a particular embodiment, the second thermal conductivity at about 25° C. can be less than about 2 k and greater than about 0.1 k.

In an embodiment for forming a porous article, a material may be provided within a mold, and a first material may be configured to form a first distinct nucleation region within a material formed within the mold. In an embodiment, the material formed within the mold may include a porous article formed from a slurry. For example, referring to FIG. 2 in particular, the slurry 202 may be provided within a mold 200. In particular embodiments, the slurry 202 may be provided within the interior surface 106 of the mold 200.

In an embodiment for forming a porous article, the temperature of the first material 104 may be reduced relative to the second material 115 to form a first distinct nucleation region within the material formed within the mold. In an embodiment, the temperature of the first and second materials 104 and 115, respectively, may be reduced from a temperature above freezing (e.g. room temperature) to form a first distinct nucleation region within the material formed within the mold. It will be appreciated that the temperature of the first and second materials 104 and 115, respectively, may be reduced from a temperature above freezing (e.g. room temperature) before or after a material is provided within the mold. It will also be appreciated that, in accordance with the embodiments described herein, a difference in thermal conductivity between the first and second materials may contribute to the formation of a first distinct nucleation region being formed with the material formed within the mold. As particularly illustrated in FIG. 2, for example, liquid nitrogen 201 may be provided to the first material 104 to reduce the temperature of the first material 104. As illustrated in FIG. 3, distinct nucleation regions 301 (a, b, c, and d) may be formed in the slurry. In particular embodiment, the distinct nucleation regions 301 may extend generally from the first material 104.

### Methods for Forming Porous Articles

The following is directed to processes that may be suitable for forming porous articles including a burst-like distribution of porosity, which may be useful in a variety of applications.

In one aspect, a method for forming a porous article can be initiated at a first step that includes providing a powder. In an embodiment, the powder can include a material, such as a ceramic, which can include a compound or composite material, including a non-metal element and a metal element. In some instances, the powder may include a material selected from the group of an organic material, an inorganic material, a ceramic material, a vitreous material, an oxide, a nitride, a carbide, a boride, an oxynitride, an oxycarbide, zirconia (ZrO₂), yttria (Y), ytterbium (Yb), cerium (Ce), scandium (Sc), samarium (Sm), gadolinium (Gd), lanthanum (La), praseodymium (Pr), neodymium (Nd), yttria stabilized zirconia (YSZ), 8 mol % Y₂O₃-doped ZrO₂ or 10 mol % Y₂O₃-doped ZrO₂, Y₂ZrO₇, lanthanum (La), manganese (Mn), strontium (Sr), lanthanum strontium manganite (LSM), (La_{0.80}Sr_{0.20})_{0.98}MnO_{3-δ}, lanthanum strontium titanate (LST), NiO, and a combination thereof. In some instances, the powder can include a material doped with another material, such as, for example, an aliovalent transition metal, such as, for example, manganese (Mn), nickel (Ni), cobalt (Co), niobium (Nb), or iron (Fe). In some instances, the powder can include a material including a polymer. In some instances, the powder can include a material including a resin. In an embodiment, the powder can include material useful as a cathode of a solid oxide fuel cell. In another embodiment, the powder can include material useful as gas separation membrane. In another embodiment, the powder can include material useful as a catalyst carrier. In another embodiment, the powder can include material useful as an anode of a solid oxide fuel cell. In particular instances, the powder may consist essentially of lanthanum strontium manganite (LSM) material. In particular instances, the powder may consist essentially of yttria stabilized zirconia (YSZ) material. In particular instances, the powder may consist essentially of lanthanum strontium titanate (LST) material. It will be appreciated that the powder may include a mixture of materials including, but not limited to, any combination of the materials described herein.

In accordance with an embodiment, the powder can have an average particle size that may be not greater than about 500 microns. In other embodiments, the average particle size, which may also be considered the median particle size (D₅₀), may be not greater than about 400 microns, such as not greater than about 300 microns, not greater than about 200 microns, not greater than about 100 microns, not greater than about 80 microns, or even not greater than about 50 microns. Still, in one non-limiting embodiment, the powder may have an average particle size that can be at least about 1 nm, such as at least about 10 nm, at least about 50 nm, at least about 0.1 microns, at least about 0.5 microns, at least about 0.8 microns, or even at least about 1 micron. It will be appreciated that the powder can have an average particle size within a range between any of the minimum and maximum values noted above.

The powder may define a Gaussian or normal particle size distribution. In other embodiments, the powder may define a non-Gaussian particle size distribution. For example, in one embodiment the powder may define a multimodal particle size distribution, such that multiple modes of particle sizes are identified and distinct from each other. In certain instances, the powder may define a bimodal particle size distribution.

As will be appreciated, and as noted herein, the powder may include a mixture of at least two different types of powder materials having two distinct compositions. In particular instances, the powder may include a mixture, wherein each of the distinct powder compositions can define a distinct mode of the particle size distribution. For example, the powder can include a first composition defining a first mode of the particle size distribution, and a second composition having a distinct composition from the first composition and defining a second mode of the particle size distribution, wherein the second mode defines a distinct particle size relative to the first mode.

The powder may further contain limited amounts of certain impurity materials, including for example free-carbon. In particular instances, the powder may contain less than 1% carbon material, and more particularly less than 0.1%, or even less than 0.01% carbon or carbon-based material.

In accordance with another embodiment, the powder can be formed into a mixture. The mixture may include a dry mixture or a wet mixture. In particular instances, the wet mixture can be in the form of a slurry, which can include the component and a carrier, such as a liquid carrier. In particular instances, the liquid carrier may include water.

In one particular embodiment, the process of creating a mixture can include forming a slurry having a pH that may be particularly controlled. For example, the slurry can have a pH that can be basic. In more particular instances, the slurry can have a pH of not greater than about 10, such as not greater than about 11, not greater than about 12, or not even greater than about 13. Still, in one non-limiting embodiment, the pH of the mixture can be at least about 3, such as at least about 5, at least about 6, at least about 7, at least about 8, or even at least about 9. It will be appreciated that in one embodiment, the mixture can have a pH within a range of any of the minimum and maximum values noted above.

In one particular embodiment, the process of forming can include creating a mixture of a slurry having at least one additive. Certain suitable additives can be selected from the group of materials, such as binders, plasticizers, surfactants, sintering aids, dispersants, and a combination thereof. In an embodiment, the mixture or slurry may include the powder and an additive, which may include a sintering aid. Some suitable sintering aids can include a ceramic, a glass, a polymer, a natural material, and a combination thereof. More particularly, the sintering aid may include a metal such as nickel; or an oxide, nitride, boride, carbide, and a combination thereof. It will be appreciated that the mixture or slurry may include a minority content of the additive as compared to the content of powder. For example, the mixture or slurry may include a minority content of the dispersant, including a content of less than about 20 volume percent (vol %) of the total volume of the mixture.

After providing the slurry, the process can continue at another step, which can include forming a green body including the slurry. It will be appreciated that reference to a green body is reference to an unsintered body, which may undergo further processing for complete or full densification. In accordance with an embodiment, the process of forming the slurry into a green body can include processes, such as mixing, molding, casting, depositing, pressing, punching, printing, spraying, drying, sintering, and a combination thereof. In particular instances, the process of forming the mixture into the green body can include a particular drying operation, such as a freeze-drying operation. In accordance with an embodiment, the process of forming more particularly, the mixture into the green body can include a freezing process, such as a freeze-casting process. It will be appreciated that the freeze-casting process may mold the mixture into a particular shape while also removing or changing the phase (e.g. freezing, melting, or evaporating or drying) of certain components from the mixture to form the green body. As used herein, the term freeze-casting and freeze-cast may be used synonymously. Freeze casting is a process that may be used to produce porous articles according to embodiments described herein. The process may involve solidifying a solvent in a slurry to produce a frozen network, subliming the frozen solvent (e.g., through a process of freeze-drying), and sintering the remaining porous powder network. As an illustrative, non-limiting example, the frozen solvent may be ice. Characteristics of a pore network include percent porosity, connectivity of pores, pore shape, size and size distribution, specific surface area, and tortuosity. Directional solidification conditions may have an effect on the orientation of porosity in the freeze cast microstructure. Oriented porosity may improve gas diffusion and reduce tortuosity. Further, with freeze-casting technology, finer powders (higher strength) can be used, and there may be no need for pore formers (simpler burnout and minimal EHS concerns).

In accordance with an embodiment, a method for forming a porous article may include forming a first solid phase within the slurry by extending a first group of projections in a burst-like distribution from a first cold point. In another embodiment, forming a first solid phase within the slurry may include extending a second group of projections in a burst-like distribution from a second cold point, the second group of projections being distinct from the first group of projections, and the second cold point being spaced apart from the first cold point. In yet another embodiment, the burst-like distribution of porosity includes a first group of porosity channels and a second group of porosity channels distinct from the first group of porosity channels, the first group of porosity channels extending from a first cold point, and the second group of porosity channels extending from a second cold point spaced apart from the first cold point.

It will be understood that a cold point as described herein may be provided by decreasing a temperature of a first material relative to an initial temperature of the first material in thermal contact with the slurry. In an embodiment, the temperature of the first material may be decreased by reducing the thermal energy of the first material. In some instances, reducing the thermal energy of the first material may include providing dry ice or cold substance to the first material. In a particular instance, reducing the thermal energy of the first material may include providing liquid nitrogen to the first material.

In accordance with an embodiment, the thermal energy of the first material may be reduced for a particular amount of time. In certain instances, the thermal energy of the first material may for at least about 1 minute, such as at least about 10 minutes, such as at least about 30 minutes, at least about 1 hour, at least about 2 hours, or even at least about 3 hours. In a non-limiting embodiment, reducing the thermal energy of the first material may include reducing the thermal energy of the material for not greater than about 24 hours, such as not greater than about 18 hours, not greater than about 12 hours, not greater than about 10 hours, not greater than about 8 hours, not greater than about 6 hours, not greater than about 4 hours, not greater than about 2 hours, not greater than about 1 hour, not greater than about 30 minutes, or even not greater than about 10 minutes. It will be appreciated that the thermal energy of the first material may be reduced for an amount of time necessary to ensure that the entire volume of the slurry within the mold is frozen.

In an embodiment, a nucleation region may be associated with a cold point. In a particular embodiment, a first nucleation region may be associated with a first cold point, and a second nucleation region distinct from the first nucleation region may be associated with a second cold point spaced apart from the first cold point. In certain instances, the first, second, and third cold points may be arranged in a predetermined distribution with respect to each other. In more particular instances, forming a porous article may include forming a plurality of cold points arranged in a predetermined distribution with respect to each other. In still another particular instance, a nucleation region may be formed in the slurry at a location associated with a cold point. It will be appreciated that a plurality of nucleation regions may be formed in the slurry at a plurality of locations associated with a plurality of cold point.

As discussed herein, forming a porous article may include forming a first group of porosity channels having a burst-like distribution of porosity extending from the first nucleation region associated with the first cold point. In another embodiment, forming a porous article may further include forming a second group of porosity channels spaced apart from the first group of porosity channels, the second group of porosity channels having a burst-like distribution of porosity extending from the second nucleation region associated with the second cold point. In still another embodiment, forming a porous article may further include forming a third group of porosity channels distinct from the first and second groups of porosity channels, the third group of porosity channels having a burst-like distribution of porosity and extending from a third cold point spaced apart from the first and second cold points. In certain instances, the first, second, and third groups of porosity channels includes arranging the first, second, and third groups of porosity channels in a predetermined distribution.

In accordance with an embodiment, a method for forming a porous article may include forming a joint intersection region defined by porosity channels of the first group of porosity channels intersecting porosity channels of the second group of porosity channels. As discussed herein, a joint intersection region may be defined by porosity channels of a first group of porosity channels intersecting porosity channels of a second group of porosity channels. In another embodiment, forming a porous article may include forming a second joint intersection region defined by porosity channels of the first group of porosity channels intersecting porosity channels of a third group of porosity channels, or alternately defined by porosity channels of the second group of porosity channels intersecting porosity channels of a third group of porosity channels. In an embodiment, the first and second joint intersection regions may be arranged in a predetermined distribution with respect to each other. It will be understood that forming a porous article may include forming a plurality of joint intersection regions. In certain instances, the plurality of joint intersection regions may be arranged in a predetermined distribution with respect to each other.

In a particular embodiment, forming a porous article may include forming a second solid phase comprising the slurry, the second solid phase separate from the first solid phase, wherein the second solid phase can be formed between projections of the first group of projections of the first solid phase. Forming the burst-like distribution of porosity within the porous article may include removing the first solid phase from the porous article. Removing the first solid phase from the porous article may include melting or evaporating the first solid phase. It will be appreciated that removing the first solid phase from the porous article may include sublimation of the first solid phase. It will also be appreciated that removing the first solid phase from the porous article may be dependent on the relative freezing point of the liquid or solvent phase used in forming the slurry provided in the mold. In some instances, such as if water is used for making the slurry, a freeze drying process may be used to remove the first solid phase from the porous article. In other instances, such as if an aqueous media used for making the slurry includes a freezing point above room temperature, vacuum drying or drying in ambient conditions may be used to remove the first solid phase from the porous article.

In accordance with an embodiment, forming a porous article may include providing the slurry within a mold in accordance with the embodiments of molds described herein. In a particular embodiment, a method for morning a porous article may include providing the slurry within a mold having a first cold point and a second cold point spaced apart from the first cold point. In another embodiment, the slurry may be provided within a mold having a first material having a first thermal conductivity and a second material having a second thermal conductivity different from the first thermal conductivity, as described according to embodiments herein.

In certain instances, forming a porous article may include applying a releasing agent to the mold prior to providing the slurry within the mold. In other certain instances, forming a porous article may include removing the solid article from the mold. For instance, it will be understood that the solid article may be removed from the mold before or after further processing, such as densification (e.g. sintering).

In accordance with an embodiment, the process of forming can include densification of the green body. Some suitable densification operations can include heating, and more particularly, a sintering operation. In one particular instance, the process of forming the final-formed porous component can include a hot-pressing operation. Hot-pressing can include the application of heat and pressure to the green body to facilitate densification. In certain instances, the process of hot-pressing can be conducted at a pressure of at least about 1,000 psi, such as at least about 1,500 psi, at least about 2,000 psi, or even at least about 3,000 psi. Still, in another non-limiting embodiment, the pressure utilized during hot-pressing can be not greater than about 10,000 psi, such as not greater than about 20,000 psi, not greater than about 50,000 psi, not greater than about 75,000 psi, not greater than about 90,000 psi, or even not greater than about 100,000 psi. It will be appreciated that the pressure utilized during hot-pressing can be within a range between any of the minimum and maximum pressures noted above.

In accordance with another embodiment, the process of hot-pressing can be conducted at a hot-pressing temperature. For example, the hot-pressing temperature can be at least about 800° C., at least about 1000° C., at least about 1,500° C., such as at least about 1,700° C., or even at least about 1,900° C. Still, in one non-limiting embodiment, the hot-pressing temperature can be not be greater than about 2,000° C., such as not greater than about 2,100° C., or even not greater than about 2,200° C. It will be appreciated that the hot-pressing temperature can be within a range between any of the above minimum and maximum values. Furthermore, it will be appreciated that the conditions for facilitating formation (e.g., desification) of the porouscomponent into a ready state for use as an armor component are contemplated and within the scope of the present invention described in accordance with the embodiments herein. For example, in an embodiment, hot-pressing may be performed at a temperature of at least about 1,600° C. and at a pressure of at least about 2,000 psi.

In another particular instance, the process of forming the final-formed porouscomponent can include a pressureless sintering operation. Pressureless sintering can include the application of heat and pressure to the green body to facilitate densification. In certain instances, the process of pressureless sintering can be conducted at a pressure provided under vacuum or inert atmospheric pressures. In certain instances, the process of pressureless sintering can be conducted at a pressure of at least about 0 psi, such as at least about 5 psi, at least about 10 psi, at least about 14 psi, at least about 14.6 psi, or even at least about 14.7 psi. Still, in another non-limiting embodiment, the pressure utilized during pressureless sintering can be not greater than about 20 psi, such as not greater than about 15 psi, not greater than about 14.7 psi, not greater than about 14.6 psi, not greater than about 10 psi, or even not greater than about 5 psi. It will be appreciated that the pressure utilized during pressureless sintering can be within a range between any of the minimum and maximum pressures noted above.

In accordance with another embodiment, the process of pressureless sintering can be conducted at a pressureless sintering temperature. For example, the pressureless sintering temperature can be at least about 300° C., such as at least about 450° C., at least about 500° C., at least about 700° C., at least about 1000° C., at least about 1,400° C., at least about 1,450° C., at least about 1,500° C., at least about 1,700° C., or even at least about 1,900° C. Still, in one non-limiting embodiment, the pressureless sintering temperature can be not be greater than about 2,000° C., such as not greater than about 2,100° C., or even not greater than about 2,200° C. It will be appreciated that the pressureless sintering temperature can be within a range between any of the above minimum and maximum values. In a particular embodiment, pressureless sintering may be conducted under vacuum or inert atmospheric pressure at a pressureless sintering temperature of at least about 1,600° C.

In another particular instance, the process of forming the final-formed porouscomponent can include a spark plasma sintering operation. Spark plasma sintering can include the application of heat and pressure to the green body to facilitate densification. In certain instances, the process of spark plasma sintering can be conducted at a pressure of at least about 1,000 psi, such as at least about 1,500 psi, at least about 2,000 psi, or even at least about 3,000 psi. Still, in another non-limiting embodiment, the pressure utilized during spark plasma sintering can be not greater than about 10,000 psi, such as not greater than about 20,000 psi, not greater than about 50,000 psi, not greater than about 75,000 psi, not greater than about 90,000 psi, or even not greater than about 100,000 psi. It will be appreciated that the pressure utilized during spark plasma sintering can be within a range between any of the minimum and maximum pressures noted above.

In accordance with another embodiment, the process of spark plasma sintering can be conducted at a spark plasma sintering temperature. For example, the spark plasma sintering temperature can be at least 800° C., at least 1000° C., at least about 1,500° C., such as at least about 1,700° C., or even at least about 1,900° C. Still, in one non-limiting embodiment, the spark plasma sintering temperature can be not be greater than about 2,000° C., such as not greater than about 2,100° C., or even not greater than about 2,200° C. It will be appreciated that the spark plasma sintering temperature can be within a range between any of the above minimum and maximum values. Furthermore, it will be appreciated that the conditions for facilitating densification while also facilitating formation of the porouscomponent in a ready state for use as an armor component are contemplated and within the scope of the present invention described in accordance with the embodiments herein. For example, in an embodiment, spark plasma sintering may be performed at a temperature of at least about 1,600° C. and at a pressure of at least about 2,000 psi.

In another embodiment, the process of forming the powder into a porous component can include the process of hot-pressing, which may be conducted in a controlled atmosphere. For example, hot-pressing may be conducted in an inert atmosphere. Furthermore, the content of certain impurities, including, for example, carbon within the forming chamber, may be controlled during hot-pressing. As such, in at least one embodiment, the hot-pressing process may be conducted in an atmosphere containing less than 100 ppm of carbon.

After completing the forming process, a porous component is formed. The porous component can have certain features, which are described in greater detail herein in accordance with the embodiments.

Additionally, the porous article according to embodiments described herein can include grains defining a particular grain size distribution. For example, the grains of the porous article can define a generally normal or Gaussian distribution of grain sizes. In other embodiments, the distribution of grain sizes within the porous article can be defined by a multimodal grain size distribution. For example, in one particular instance, the porous article can include grains defining a bimodal grain size distribution, including grains having a fine grain size and a second portion of grains having a course grain size, wherein the course grain size defines a distinct mode of grains having a larger average grain size than the average grain size of the grains having a finer grain size.

In accordance with an embodiment, a method for forming a porous article may include forming a porous article including a burst-like distribution of porosity.

### Porous Articles

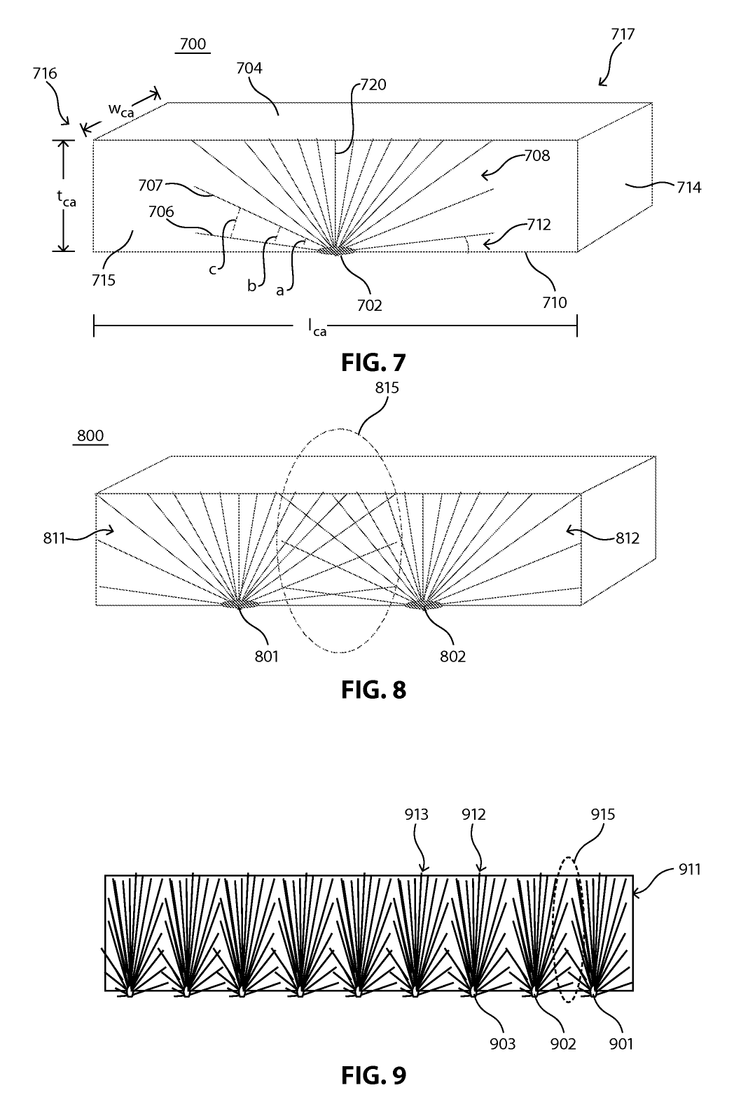

FIG. 7 includes a perspective view illustration of a porous article 700 according to an embodiment. As illustrated, the porous article 700 can include a first surface 710 and a second surface 704 that can be separate and spaced apart from the first surface 710. As illustrated, the porous article 700 can have a length (l_{ca}), a width (w_{ca}), and a thickness (t_{ca}). The length (l_{ca}) may define the longest dimension of the body of the porous article 700. The width (w_{ca}) may extend in a direction perpendicular to the length (l_{ca}) and can define a second longest dimension of the body of the porous article 700. The thickness (t_{ca}) of the body of the porous article 700 can extend in a direction perpendicular to the plane defined by the width (w_{ca}) and length (l_{ca}) of the porous article 700, and may further define the smallest dimension of the porous article 700. In at least one embodiment, the porous article 700 can have a width (w_{ca}) that may be greater than the thickness (t_{ca}), and a length (l_{ca}) may be greater than the width (w_{ca}).

As illustrated in FIG. 7, the porous article 700 may define a generally polygonal structure. For example, in accordance with an embodiment, the first surface 710 and the second surface 704 may define exterior surfaces of the porous article 700. In an embodiment, the porous article 700 may include a thickness (t_{ca}), which may be defined as a distance between the first surface 710 and the second surface 704. In an embodiment, the second surface 704 may be spaced apart from the first surface 710, and in particular instances, the second surface 704 may be spaced apart from the first surface 710 by the dimension of the thickness (t_{ca}) of the porous article 700. As will be appreciated, the first surface 710 and second surface 704 of the body of the porous article 700 may be defined generally by the dimensions of length and width of the porous article 700. As further illustrated, the porous article 700 can include side surfaces 714, 715, 716, and 717 extending between the first surface 710 and second surface 704 and further defining the thickness (t_{cc}) of this porous article 700. In accordance with an embodiment, the first surface 710 may include a first surface area (sa_{ca}), in which an entire surface area of the first surface area (sa_{ca}) may be defined as the product of the length (l_{ca}) and the width (w_{ca}) of the porous article 700.

As illustrated in FIG. 7, the porous article 700 can have a particular thickness (t_{cc}). In accordance with an embodiment, the porous article 700 can have a thickness of at least about 0.01 microns. In other embodiments, the thickness of the porous component can be greater, such as at least about 0.1 microns, at least about 1 micron, at least about 5 microns, at least about 10 microns, at least about 20 microns, at least about 30 microns, at least about 50 microns, at least about 100 microns, at least about 200 microns, at least about 500 microns, at least about 1 mm, at least about 5 mm, at least about 10 mm, at least about 12 mm, or even at least about 15 mm. Still, in a non-limiting embodiment, the porous component may have a thickness that can be not greater than about 200 mm, such as not greater than about 150 mm, not greater than about 100 mm, not greater than about 50 mm, not greater than about 20 mm, not greater than about 15 mm, not greater than about 12 mm, not greater than about 10 mm, or even not greater than about 5 mm. In certain instances, the porous component may have a thickness of not greater than about 20 mm, and at least about 0.02 mm. However, it will be appreciated that the thickness of the porous article 700 can be within a range between any of the minimum and maximum values noted above.

In accordance with an embodiment, the porous article 700 can have a two-dimensional shape. For example, as illustrated in FIG. 7, the porous article 700 can be in the form of a layer. As further illustrated, the porous article 700 can be a layer having a first surface 710 and second surface 704 defining a particular polygonal two-dimensional shape. In certain instances, the length and width of the porous article 700 can define a particular two-dimensional shape, such as a polygon, ellipsoid, circle, indicia, Roman numeral, Roman alphabet character, Kanji character, and a combination thereof. It will be appreciated that the porous article 700 can have a two-dimensional shape in the plane defined by the length and width of the porous article 700 having any suitable or desirable two-dimensional shape.

In accordance with another embodiment, the porous article 700 can have a two-dimensional shape including at least four (4) distinct sides, such as, for example, a trapezoidal shape. In at least another embodiment, the porous article 700 can have a shape including at least six (6) distinct sides. For example, as illustrated in FIG. 7, the porous article 700 can be in the form of a generally cube-like shape including six (6) distinct sides including the first surface 710, a second surface 704, and the side surfaces 714, 715, 716, and 717. It will be appreciated, however, that in other embodiments, the porous article can include a greater number of sides, including at least about 7 distinct sides, at least about 8 distinct sides, at least about 9 distinct sides, or even at least about 10 distinct sides. Still, it will be appreciated that in other embodiments, the porous article can include fewer than four (4) distinct sides, such as in the case of a disc. For example, as illustrated in the embodiments of FIGS. 4 and 5, the porous article according to embodiments described herein can have a generally disc or “puck” shape. It will be appreciated that the porous article 700 is a non-limiting example, and that other shapes can be utilized. For example, the porous article may include a tube or rod shape.

In one embodiment, the porous article 700 can include at least one material phase including a solid phase, a liquid phase, a gas phase, and a combination thereof. That is, the porous article 700 need not necessarily consist essentially of a solid phase material. However, it will be appreciated that in at least one embodiment, the porous component may consist essentially of a solid phase. In yet another embodiment, the porous article 700 may consist essentially of a liquid phase. In still another embodiment, the porous component may be formed of a mixture of phases (e.g., solid and liquid phases). More particularly, the porous article 700 may be a component that comprises at least a majority content of a solid phase. It will be appreciated that reference herein to the phases is reference to the state of the porous article 700 under standard atmospheric conditions.

In accordance with an embodiment, the porous article 700 can include an organic material that can include a compound or composite material. In particular instances, the porous article 700 can include an organic material, an inorganic material, a ceramic material, a vitreous material, an oxide, a nitride, a carbide, a boride, an oxynitride, an oxycarbide, and a combination thereof. In particular instances, the porous article 700 may include a material having a non-metal element and a metal element. In other particular instances, the porous article 700 can include a material including a polymer. In particular instances, the porous article 700 can include a material including a resin.

In an embodiment, the porous article 700 can include material useful as a cathode of a solid oxide fuel cell. In another embodiment, the porous article 700 can include material useful as an anode of a solid oxide fuel cell. In certain instances, the porous article 700 can include lanthanum strontium manganite (LSM) material. In more particular instances, the porous article 700 may consist essentially of lanthanum strontium manganite (LSM) material. In certain instances, the porous article 700 can include yttria stabilized zirconia (YSZ) material. In more particular instances, the porous article 700 may consist essentially of yttria stabilized zirconia (YSZ) material. In certain instances, the porous article includes lanthanum strontium titanate (LST) material. In more particular instances, the porous article 700 may consist essentially of lanthanum strontium titanate (LST) material. In other instances, the porous article 700 can include a material doped with another material, such as, for example, an aliovalent transition metal, such as, for example, manganese (Mn), nickel (Ni), cobalt (Co), niobium (Nb), or iron (Fe).

In accordance with an embodiment, the porous article 700 may include a particular content of porosity. For example, the porous article 700 may have a porosity of at least about 5 vol %, such as at least about 10 vol. %, at least 15 vol %, such as at least 20%, such as at least 25%, at least about 30 vol %, at least about 33 vol %, at least about 40 vol %, about 45 vol %, at least about 50 vol %, at least about 55 vol %, at least about 60 vol %, at least about 65 vol %, at least about 70 vol %, at least about 75 vol %, at least about 80 vol %, at least about 85 vol %, or even at least about 90 vol %. Still, in other non-limiting embodiments, the porous article 700 may have a porosity of not greater than about 90 vol %, such as not greater than bout 85 vol %, not greater than about 80 vol %, not greater than about 75 vol %, not greater than about 70 vol %, not greater than about 65 vol %, not greater than about 60 vol %, not greater than about 55 vol %, not greater than about 50 vol %, not greater than about 45 vol %, not greater than about 40 vol %, not greater than about 33 vol %, not greater than about 30 vol %, not greater than about 25 vol %, not greater than about 20 vol %, not greater than about 15 vol %, not greater than about 10 vol %, or even not greater than about 5 vol %. It will be appreciated that the porous article 700 may include a porosity that is within a range between any of the maximum and minimum values noted above.

In accordance with an embodiment, the porous article 700 may include porosity channels that intersect the first surface 710. In an embodiment, the porous article 700 may include porosity channels that intersect the second surface 704. In an embodiment, the porous article 700 may include porosity channels that intersect both the first surface 710 and the second surface 704. In a particular embodiment, a portion of porosity channels of the first group 708 of porosity channels may intersect the second surface 704. In another non-limiting embodiment, the portion of porosity channels of the first group 708 of porosity channels that may intersect the second surface 704 include a minority of porosity channels. In still another instance, the portion of porosity channels of the first group 708 of porosity channels that may intersect the second surface 704 may include a majority of porosity channels. In another non-limiting embodiment, a majority of the porosity channels of the first group 708 of porosity channels may intersect the second surface 704 at a substantially non-normal angle relative to the first surface 710.

In accordance with an embodiment, the porous article 700 may include a first discrete nucleation region 702. In an embodiment, the first discrete nucleation region 702 may be located between the first surface 710 and the second surface 704. In a particular embodiment, the first discrete nucleation region 702 may form a portion of the first surface 710, as illustrated in FIG. 7.

In a particular embodiment, as also illustrated in FIG. 7, the first discrete nucleation region 702 may occupy less than an entire surface of the first surface 710. More particularly, the first discrete nucleation region 702 may occupy less than an entire surface area of the first surface area (sa_{ca}) of the first surface 710. In accordance with certain instances, the first discrete nucleation region 702 may form less than about 90% of the first surface area (sa_{ca}) of the first surface 710, such as less than about 80%, less than about 70%, less than about 60%, less than about 50%, less than about 40%, less than about 30%, less than about 20%, less than about 10%, less than about 9%, less than about 8%, less than about 7%, less than about 6%, less than about 5%, less than about 4%, less than about 3%, less than about 2%, or even less than about 1%. In other non-limiting instances, the first discrete nucleation region 702 may form at least about 1% of the first surface area of the first surface 710, such as at least about 2%, at least about 3%, at least about 4%, at least about 5%, at least about 6%, at least about 7%, at least about 8%, at least about 9%, at least about 10%, at least about 20%, at least about 30%, at least about 40%, at least about 50%, at least about 60%, at least about 70%, at least about 80%, or even at least about 90%. It will be appreciated that the first discrete nucleation region 702 may occupy a percentage of the first surface area (sa_{ca}) within a range between any of the minimum and maximum percentages noted above.

In accordance with an embodiment, the porous article 700 may include porosity channels. In accordance with a particular embodiment, the porous article 700 may include porosity channels that extend from the first discrete nucleation region 702. For example, as illustrated in FIG. 7, the porous article 700 may include porosity channels of the first group of porosity channels 708 that may extend from the first discrete nucleation region 702. Furthermore, in accordance with certain aspects, a majority of porosity channels of the first group of porosity channels 708 may intersect each other at the first discrete nucleation region 702. As will be appreciated from the illustration of the embodiment of FIG. 7, the first group of porosity channels 708 may extend from the first discrete nucleation region 702 in a burst-like distribution.

As used herein, a burst-like distribution of porosity may be used to describe the structure of porosity channels described in accordance with the embodiments herein. It will be appreciated that a burst-like distribution of porosity may be defined in one or more ways with respect to other features of the embodiments. It will also be appreciated that different descriptions of a burst-like distribution of porosity may or may not describe embodiments that are necessarily unique from other embodiments described herein. In certain instances, a burst-like distribution may be defined by a majority of the porosity channels of the first group of porosity channels 708 extending at an acute angle relative to the first surface 701. That is, a burst-like distribution may be defined by a majority of the porosity channels of the first group of porosity channels 708 extending from the first discrete nucleation region 702 at a substantially non-normal angle relative to the first surface 710. For example, as illustrated in FIG. 7, porosity channel 720 represents a porosity channel extending at a substantially normal angle relative to the first surface 710. Further, angle 712 represents a sweep of an acute angle, defined by an angle less than 90° but greater than 0° relative to the origin from which the first group of porosity channels 708 extend (i.e., the first discrete nucleation region 702) and the first surface 701. As illustrated in FIG. 7, at least a portion of a majority of the first group of porosity channels 708 may be included within the sweep of angle 712. As will be appreciated, however, the sweep of angle 712 may be reproduced at any point along a circumference having a center defined by the first discrete nucleation region 702. Thus, it will be appreciated that a majority of the porosity channels of the first group of porosity channels 708 may extend at an acute angle 712, as the acute angle 712 is described above. In particular instances, a majority of the porosity channels 708 of the first group of porosity channels 708 may extend at an acute angle relative to the first surface 701 that may be not greater than about 85°, such as not greater than about 80°, not greater than about 75°, not greater than about 70°, not greater than about 65°, not greater than about 60°, not greater than about 55°, not greater than about 50°, not greater than about 45°, not greater than about 40°, not greater than about 35°, not greater than about 30°, not greater than about 25°, not greater than about 20°, not greater than about 15°, not greater than about 10°, not greater than about 5°, not greater than about 4°, not greater than about 3°, not greater than about 2°, or even not greater than about 1°. In other non-limiting instances, a majority of the porosity channels 708 of the first group of porosity channels 708 may extend at an acute angle relative to the first surface 701 that can be at least about 1°, such as at least about 2°, at least about 3°, at least about 4°, at least about 5°, at least about 10°, at least about 15°, at least about 20°, at least about 25°, at least about 30°, at least about 35°, at least about 40°, at least about 45°, at least about 50°, at least about 60°, at least about 65°, at least about 70°, at least about 75°, at least about 80°, at least about 85°. It will be appreciated that the angle can be within a range between any of the minimum and maximum percentages noted above.

In certain instances, a burst-like distribution may be defined by a majority of porosity channels of the first group of porosity channels 708 diverging away from each other as a distance from the first discrete nucleation region 702 increases. For instance, in a certain aspect, an average distance between porosity channels of the first group of porosity channels 708 may increase as a distance from the first discrete nucleation region 702 increases. As illustrated in FIG. 7, a distance between porosity channel 706 and porosity channel 707 may be defined at certain points along their respective lengths as they (i.e., porosity channel 706 and porosity channel 707) extend from the first discrete nucleation region 702. In particular, the distance between porosity channel 706 and porosity channel 707 can be defined at points along their respective lengths at which instances “a,” “b,” and “c,” intersect porosity channel 706 and porosity channel 707. As illustrated, and as will be appreciated, instances “a,” “b,” and “c,” preferably represent imaginary lines having respective lengths and intersecting porosity channel 706 and porosity channel 707 at normal (perpendicular) angles. As will also be appreciated, a distance between instance “c” and the first discrete nucleation region 702 can be understood to be greater than the distance between instances “b” or “a” and the first discrete nucleation region 702. Likewise, a distance between instance “b” and the first discrete nucleation region 702 can be understood to be greater than the distance between instance “a” and the first discrete nucleation region 702. As also illustrated, and will be appreciated, the average distance between porosity channel 706 and porosity channel 707 can increase as the distance from the first discrete nucleation region 702 increases in the direction of instances “a” to “b” to “c” such that the distance between porosity channel 706 and porosity channel 707 at instance “c” can be greater than at instances “b” or “a” and, likewise, the distance between porosity channel 706 and porosity channel 707 at instance “b” can be greater than at instance “a.” As will be understood, the relationship between porosity channel 706, porosity channel 707, and the first discrete nucleation region 702 can be representative of any adjacent porosity channels described in accordance with the embodiments herein.

In another instance, the divergence with which a majority of porosity channels of the first group of porosity channels 708 may diverge away from each other as a distance from the first discrete nucleation region 702 increases may be defined as the increase in average distance between the porosity channels of the first group of porosity channels 708 as a distance from the first discrete nucleation region 702 increases. In a particular aspect, a majority of the porosity channels of the first group of porosity channels 708 diverge from each other and define a divergence angle of at least about 1° as viewed in a cross-section defined by a height and a width of the porous article 700, such as at least about 3°, at least about 5°, at least about 10°, at least about 20°, at least about 30°, at least about 40°, at least about 45°, at least about 60°, at least about 70°, at least about 80°, or even at least about 85°.

In certain instances, a burst-like distribution may also be defined with respect to the relationship between central axes of adjacent porosity channels. For example, in an embodiment, each porosity channel within the first group of porosity channels 708 may have a central axis defining a vector. In a particular embodiment, a majority of the vectors of each porosity channel within the first group of porosity channels 708 may be different with respect to each other. For example, the relationship between central axes of adjacent porosity channels may be defined by an adjacent angle between central axes of adjacent porosity channels of the first group of porosity channels, as viewed from a side perspective cross-sectional view of the porous article such as that shown in FIG. 7 In particular instances, the adjacent angle may be at least about 1°, such as at least about 2°, at least about 3°, at least about 4°, at least about 5°, at least about 10°, at least about 15°, at least about 20°, at least about 25°, at least about 30°, at least about 35°, at least about 40°, at least about 45°, at least about 50°, at least about 60°, at least about 65°, at least about 70°, at least about 75°, at least about 80°, at least about 85°, at least about 90°, at least about 95°, at least about 100°, at least about 105°, at least about 110°, at least about 115°, at least about 120°, at least about 125°, at least about 130°, at least about 135°, at least about 140°, at least about 145°, at least about 150°, at least about 155°, at least about 160°, at least about 165°, at least about 170°, or even at least about 175. In an embodiment, the adjacent angle may be not greater than about 175°, such as not greater than about 170°, not greater than about 165°, not greater than about 160°, not greater than about 155°, not greater than about 150°, not greater than about 145°, not greater than about 140°, not greater than about 135°, not greater than about 130°, not greater than about 125°, not greater than about 120°, not greater than about 115°, not greater than about 110°, not greater than about 105°, not greater than about 100°, not greater than about 95°, not greater than about 90°, not greater than about 85°, not greater than about 80°, not greater than about 75°, not greater than about 70°, not greater than about 65°, not greater than about 60°, not greater than about 55°, not greater than about 50°, not greater than about 45°, not greater than about 40°, not greater than about 35°, not greater than about 30°, not greater than about 25°, not greater than about 20°, not greater than about 15°, not greater than about 10°, not greater than about 5°, not greater than about 4°, not greater than about 3°, not greater than about 2°, or even not greater than about 1°. It will be appreciated that the angle can be within a range between any of the minimum and maximum percentages noted above.

In an embodiment, a portion of the central axes of the porosity channels within the first group of porosity channels 708 may intersect the first discrete nucleation region 702 at a first acute angle with respect to the first surface 710, and may intersect the second surface 704 at a second acute angle with respect to the second surface 704. In a certain instance, the first acute angle and the second acute angle may be substantially the same angle.

In certain instances, a burst-like distribution may also be defined by a majority of porosity channels of the first group of porosity channels 708 extending radially and axially from the first discrete nucleation region 702. It will be appreciated that extending radially means radiating from, or converging to, a common center. It will also be appreciated that extending axially means extending in the direction of, or line of, an axis.

In at least one embodiment, a burst-like distribution can be defined by a majority of porosity channels of the first group of porosity channels 708 extending at a substantially non-parallel angle relative to the direction of the thickness (t_{ca}). As will be appreciated, especially in light of the exemplary illustration of FIG. 7, the direction of the thickness (t_{ca}) can be defined as a line defining the shortest distance between the first surface 710 and the second surface 704. As illustrated in FIG. 7, porosity channel 720 can extend at a substantially parallel angle relative to the direction of the thickness (t_{ca}), and thus may define the shortest distance between the first surface 710 and the second surface 704. As illustrated in FIG. 7, the remaining porosity channels can extend at a substantially non-parallel angle relative to the direction of the thickness (t_{ca}).

In accordance with an embodiment, a porous article may include a second discrete nucleation region separate and spaced apart from the first discrete nucleation region. In an embodiment, a porous article may further include a second group of porosity channels distinct from the first group of porosity channels. In yet another embodiment, the second group of porosity channels may extend from the second discrete nucleation region. For example, FIG. 8 illustrates a porous article 800 according to an embodiment having a first discrete nucleation region 801 and a second discrete nucleation region 802. As further illustrated, a second group of porosity channels 812 can extend from the second discrete nucleation region 802. Moreover, the second group of porosity channels 812 can be distinct from a first group of porosity channels 811. As further illustrated, an average distance between porosity channels of the second group of porosity channels 812 can increase as a distance from the second discrete nucleation region 802 increases, as described in greater detail in accordance with embodiments herein.

In accordance with an embodiment, the first discrete nucleation region may have a size, and the second discrete nucleation region, can have a size. As illustrated in FIG. 8, the size of the first discrete nucleation region 801 can be substantially the same as the size of the second discrete nucleation region 802. In an embodiment, the size of the first discrete nucleation region 801 can be different than the size of the second discrete nucleation region 802. For instance, the size of the first discrete nucleation region 801 can be smaller or larger than the second discrete nucleation region 802. It will be appreciated that in certain embodiments including three or more discrete nucleation regions, the three or more discrete nucleation regions may be the same size or may be different sizes with respect to each other.

In accordance with an embodiment, at least a portion of porosity channels of a first group of porosity channels can intersect at least a portion of porosity channels of a second group of porosity channels. For example, as illustrated in FIG. 8, at least a portion of the porosity channels of the first group of porosity channels 811 can intersect at least a portion of the porosity channels of the second group of porosity channels 812 at joint intersection region 815. In an embodiment, a joint intersection region 815 may be defined by porosity channels of a first group of porosity channels 811 intersecting porosity channels of a second group of porosity channels 812.

In accordance with an embodiment, a porous article may include three or more discrete nucleation regions separate and spaced apart from each other. In an embodiment, a porous article may further include a three or more groups of porosity channels distinct from each other. In an embodiment, three or more groups of porosity channels may each extend separately and respectively from three or more discrete nucleation regions. For example, FIG. 9 illustrates a porous article 900 according to an embodiment having three or more discrete nucleation regions, 901, 902, and 903. FIG. 9 also illustrates three or more groups of porosity channels, 911, 912, and 913 extending separately and respectively from discrete nucleation regions 901, 902, and 903. As illustrated, the third discrete nucleation region 903 can be spaced apart from the first discrete nucleation region 901. As further illustrated, the third group of porosity channels 913 can be extending from the third discrete nucleation region 903.

In accordance with an embodiment, and as illustrated in FIG. 9, at least a portion of porosity channels of the two or more group of porosity channels 911, 912, and 913 can intersect at least a portion of the porosity channels of another one or more of the two or more groups of porosity channels 911, 912, and 913 defining a joint intersection region, such as, for example, joint intersection region 915. In an embodiment, a joint intersection region may be defined by porosity channels of a first group of porosity channels intersecting porosity channels of a second group of porosity channels. Moreover, a porous article described in accordance with an embodiment herein may include one or more joint intersection regions such as, for example, one or more joint intersection regions 915. In another embodiment, a joint intersection region may be defined by porosity channels of a first group of porosity channels intersecting porosity channels of a second group of porosity channels and a third group of porosity channels.

Further, the one or more joint intersection regions may be arranged in a predetermined distribution. For example, FIG. 11 illustrates a top planar view of a porous article in accordance with an embodiment. As illustrated by the dotted lines, the one or more joint intersection regions may be arranged in a predetermined distribution relative to each other, such as, for example, an array, a letter, or a polygon. It will be appreciated, however, that the one or more joint intersection regions may be arranged in one or more suitable predetermined distributions. For example, in an embodiment, the joint intersection regions may be arranged in a predetermined distribution as viewed in a plane defined by a length and a width of the porous article. It will be appreciated that a predetermined distribution of joint intersection regions can be defined by a combination of predetermined positions on a porous article that are purposefully selected. A predetermined distribution can include a pattern, such that the predetermined positions can define a two-dimensional array. An array can include have short range order defined by a unit of discrete nucleation regions. An array may also be a pattern, having long range order including regular and repetitive units linked together, such that the arrangement may be symmetrical and/or predictable. An array may have an order that can be predicted by a mathematical formula. It will be appreciated that two-dimensional arrays can be formed in the shape of polygons, ellipsis, ornamental indicia, product indicia, or other designs. A predetermined distribution can also include a controlled, non-uniform distribution, a controlled uniform distribution, and a combination thereof. In particular instances, a predetermined distribution may include a radial pattern, a spiral pattern, a phyllotactic pattern, an asymmetric pattern, a self-avoiding random distribution, a self-avoiding random distribution and a combination thereof. The predetermined distribution can be partially, substantially, or fully asymmetric. As used herein, “a phyllotactic pattern” means a pattern related to phyllotaxis. Phyllotaxis is the arrangement of lateral organs such as leaves, flowers, scales, florets, and seeds in many kinds of plants. Many phyllotactic patterns are marked by the naturally occurring phenomenon of conspicuous patterns having arcs, spirals, and whorls. The pattern of seeds in the head of a sunflower is an example of this phenomenon. In particular embodiments, the plurality of first discrete regions may be arranged in a row, a column, a circle, a square, a rectangle, or any combination thereof.

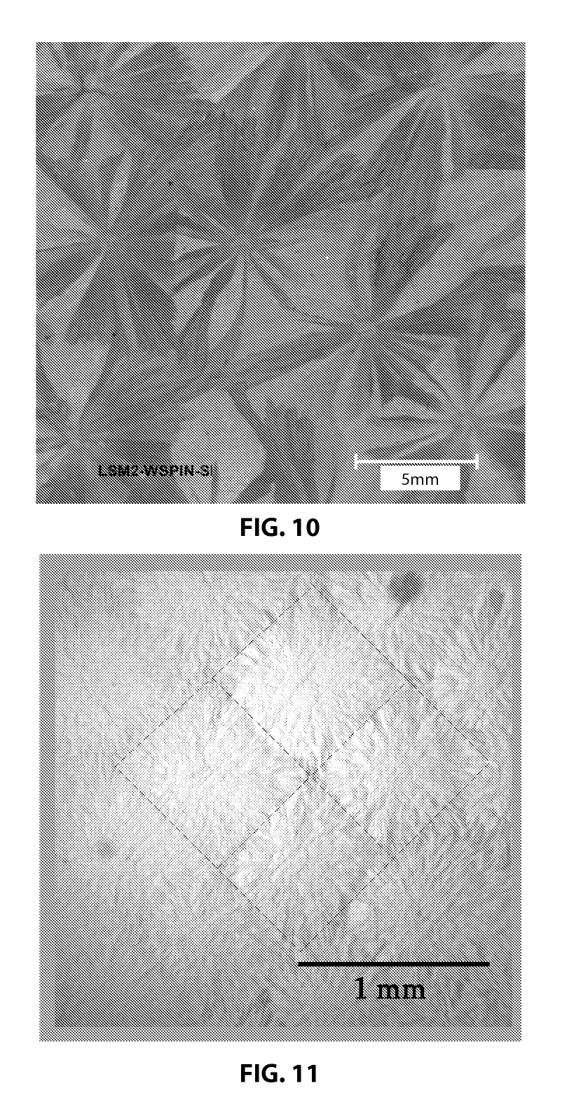

In an embodiment, a plurality of discrete nucleation regions, including, for example, the first, second, and third discrete nucleation regions, may be arranged in a predetermined distribution relative to each other. For example, FIG. 10 illustrates a bottom planar view of a porous article in accordance with an embodiment. In an embodiment, the first, second, and third discrete nucleation regions may be arranged in a predetermined distribution as viewed in a plane defined by a length and a width of the porous article. It will be appreciated that a predetermined distribution of discrete nucleation regions can be defined by a combination of predetermined positions on a porous article that are purposefully selected. A predetermined distribution can include a pattern, such that the predetermined positions can define a two-dimensional array. An array can include have short range order defined by a unit of discrete nucleation regions. An array may also be a pattern, having long range order including regular and repetitive units linked together, such that the arrangement may be symmetrical and/or predictable. An array may have an order that can be predicted by a mathematical formula. It will be appreciated that two-dimensional arrays can be formed in the shape of polygons, ellipsis, ornamental indicia, product indicia, or other designs. A predetermined distribution can also include a controlled, non-uniform distribution, a controlled uniform distribution, and a combination thereof. In particular instances, a predetermined distribution may include a radial pattern, a spiral pattern, a phyllotactic pattern, an asymmetric pattern, a self-avoiding random distribution, a self-avoiding random distribution and a combination thereof. The predetermined distribution can be partially, substantially, or fully asymmetric. As used herein, “a phyllotactic pattern” means a pattern related to phyllotaxis. Phyllotaxis is the arrangement of lateral organs such as leaves, flowers, scales, florets, and seeds in many kinds of plants. Many phyllotactic patterns are marked by the naturally occurring phenomenon of conspicuous patterns having arcs, spirals, and whorls. The pattern of seeds in the head of a sunflower is an example of this phenomenon. In particular embodiments, the plurality of first discrete regions may be arranged in a row, a column, a circle, a square, a rectangle, or any combination thereof.

In accordance with an embodiment, a porous article may be a freeze-cast porous article. It will be appreciated that a freeze-cast porous article may include an article that has been freeze-casted, freeze-dried, and sintered.

In an embodiment, a porous article as described herein may include a cathode layer or an anode layer. For example, FIG. 13 illustrates a side frontal view of an SOFC 1300 having a cathode layer 1301, electrolyte layer 1302, anode layer 1303, and interconnect layer 1304. In an embodiment, the SOFC 1300 may also include functional layers between the electrodes and the electrolyte, such as between the cathode layer 1301 and the electrolyte 1302, or between the anode layer 1303 and the electrolyte 1302. In an embodiment, the SOFC 1300 may also include bulk layers, such as, for example, a cathode bulk layer or an anode bulk layer. In an embodiment, SOFC 1300 may also include bonding layers. For example, the SOFC 1300 may include bonding layers between the interconnect 1304 and the anode layer 1303. It will be appreciated that the layers of the SOFC 1300 may be included in a component having a repeating arrangement of the layers, such as, for example, in an SOFC stack arrangement.

In an embodiment, a porous article (cathode layer 1301 or anode layer 1303) as described herein may include a porous article CTE (CTE_{ca}), the electrolyte layer 1302 may include an electrolyte (CTE_{elyte}), and the interconnect layer 1304 may include an interconnect CTE (CTE_{ic}). In accordance with an embodiment, the porous article CTE (CTE_{ca}) may be defined with respect to the CTE of the electrolyte layer 1302 (CTE_{elyte}) or the CTE of the interconnect layer 1034 (CTE_{ic}). For example, in accordance with an embodiment, the porous article CTE (i.e. CTE_{ca}) may be at least about 1% less than the electrolyte CTE (i.e., CTE_{elyte}), as measured by the equation [(CTE_{elyte}−CTE_{ca})/CTE_{elyte}]×100%. It will be appreciated that the percent difference in CTE can be measured as the absolute value of the equation noted herein. In accordance with particular instances, the porous article CTE can be at least about 2% less than the electrolyte CTE, that is, at least about 3% less, at least about 4% less, at least about 5% less, at least about 6% less, at least about 7% less, at least about 8% less, at least about 9% less, at least about 10% less, at least about 12% less, at least about 15% less, at least about 20% less, at least about 25% less, at least about 30% less, at least about 35% less, at least about 40% less, at least about 45% less, at least about 50% less, at least about 55% less, at least about 60% less, at least about 65% less, at least about 70% less, at least about 75% less, at least about 80% less, at least about 85% less, at least about 90% less, at least about 95% less, or even at least about 98% less. In accordance with an embodiment, the porous article CTE may be not greater than about 1% the value of the electrolyte CTE, such as not greater than about 2%, not greater than about 3%, not greater than about 4%, not greater than about 5%, not greater than about 6%, not greater than about 7%, not greater than about 8%, not greater than about 9%, not greater than about 10%, not greater than about 12%, not greater than about 15%, not greater than about 20%, not greater than about 25%, not greater than about 30%, not greater than about 35%, not greater than about 40%, not greater than about 45%, not greater than about 50%, not greater than about 55%, not greater than about 60%, not greater than about 65%, not greater than about 70%, not greater than about 75%, not greater than about 80%, not greater than about 85%, not greater than about 90%, not greater than about 95%, not greater than about 98%, or even not greater than about 99%. It will be appreciated that the difference in CTE between the porous article and the electrolyte can be within a range between any of the minimum and maximum percentages noted above.

In accordance with another embodiment, the porous article CTE (i.e., CTE_{ca}) may be at least about 1% less than the interconnect CTE (i.e., CTE_{ic}), as measured by the equation [(CTE_{ic}−CTE_{ca})/CTE_{ic}]×100%. It will be appreciated that the difference in CTE can be measured as the absolute value of the equation noted herein. In accordance with particular instances, the porous article CTE can be at least about 2% less than the interconnect CTE, that is, at least about 3% less, at least about 4% less, at least about 5% less, at least about 6% less, at least about 7% less, at least about 8% less, at least about 9% less, at least about 10% less, at least about 12% less, at least about 15% less, at least about 20% less, at least about 25% less, at least about 30% less, at least about 35% less, at least about 40% less, at least about 45% less, at least about 50% less, at least about 55% less, at least about 60% less, at least about 65% less, at least about 70% less, at least about 75% less, at least about 80% less, at least about 85% less, at least about 90% less, at least about 95% less, at least about 98% less, or even at least about 99% less. In accordance with an embodiment, the porous article CTE may be not greater than about 1% the value of the interconnect CTE, such as not greater than about 2%, not greater than about 3%, not greater than about 4%, not greater than about 5%, not greater than about 6%, not greater than about 7%, not greater than about 8%, not greater than about 9%, not greater than about 10%, not greater than about 12%, not greater than about 15%, not greater than about 20%, not greater than about 25%, not greater than about 30%, not greater than about 35%, not greater than about 40%, not greater than about 45%, not greater than about 50%, not greater than about 55%, not greater than about 60%, not greater than about 65%, not greater than about 70%, not greater than about 75%, not greater than about 80%, not greater than about 85%, not greater than about 90%, not greater than about 95%, not greater than about 98%, or even not greater than about 99%. It will be appreciated that the difference in CTE between the porous article and the interconnect can be within a range between any of the minimum and maximum percentages noted above.

In particular embodiments, the coating can include a material having a coefficient of thermal expansion (CTE) of not greater than about 20×10⁻⁶° C.⁻¹, such as not greater than about 15×10⁻⁶° C.⁻¹, not greater than about 12×10⁻⁶° C.⁻¹, not greater than about 11×10⁻⁶° C.⁻¹. Still, in other non-limiting embodiments, the coating can include a material having a coefficient of thermal expansion (CTE) of at least about 3×10⁻⁶° C.⁻¹, such as at least about 5×10⁻⁶° C.⁻¹, at least about 8×10⁻⁶° C.⁻¹, at least about 10×10⁻⁶° C.⁻¹, at least about 11×10⁻⁶° C.⁻¹, at least about 12×10⁻⁶° C.⁻¹. It will be appreciated that the CTE can be within a range between any of the maximum and minimum values noted above.

Items

Item 1. A mold for forming a porous article, including a base plate, the base including: a first material and a second material, wherein the first material is at least partially embedded within the second material and configured to create regions of different thermal conductivity in the base plate.

Item 2. The mold of Item 1, wherein at least one object extends at least partially through the base plate and configured to form a first discrete nucleation region within a material formed within the mold, wherein the at least one object includes a first material.

Item 3. The mold of any one of Items 1 or 2, wherein the base plate includes a plurality of first discrete regions spaced apart from each other, the plurality of first discrete regions comprising the first material, and wherein the plurality of first discrete regions are arranged in a predetermined distribution relative to each other.

Item 4. The mold of any one of the above Items, further comprising:

wherein the base plate includes a thickness;

wherein the first material includes a first thermal conductivity;

wherein the first material extends through a first portion of the thickness of the base plate;

wherein the second material includes a second thermal conductivity different from the first thermal conductivity; and

wherein the second material forms a second portion of the thickness of the base plate distinct from the first portion of the thickness of the base plate.

Item 5. The mold of Item 2, wherein the base plate includes a surface, and wherein the thickness is defined in part by the surface.

Item 6. The mold of Item 5, further comprising:

a first lateral member having a first interior lateral surface, the first lateral member attached to a first end of the base plate; and

a second lateral member having a second interior lateral surface, the second lateral member attached to a second end of the base plate.

Item 7. The mold of Item 6, further comprising:

an interior surface defined in part by the surface of the base plate, the first interior lateral surface of the first lateral member, and the second interior lateral surface of the second lateral member.

Item 8. The mold of any one of the above Items, wherein the base plate further includes an exterior surface, and wherein the first material extends through a portion of the exterior surface of the base plate.

Item 9. The mold of Item 7, wherein the first material extends through a portion of the interior surface of the mold.

Item 10. The mold of Item 2, wherein the base plate includes the plurality of first discrete regions.

Item 11. The mold of any one of the above Items, wherein the base plate is integral with the mold.

Item 12. The mold of any one of Items 6 or 11, wherein the base plate is integral with the first and second lateral members.

Item 13. The mold of any one of Items 6 or 11, wherein the first and second lateral members are integral with each other.

Item 14. The mold of Item 5, wherein the surface of the base plate is a planar surface, and wherein the first material is coplanar with the planar surface of the base plate.

Item 15. The mold of Item 7, wherein the first material occupies less than an entire surface area of the interior surface of the mold.

Item 16. The mold of Item 14, wherein the first material occupies less than an entire surface area of the planar surface of the base plate, less than about 95%, less than about 90%, less than about 85%, less than about 80%, less than about 75%, less than about 70%, less than about 65%, less than about 60%, less than about 55%, less than about 50%, less than about 45%, less than about 40%, less than about 35%, less than about 30%, less than about 25%, less than about 20%, less than about 15%, less than about 10%, less than about 5%.

Item 17. The mold of Item 14, wherein the first and second lateral members are perpendicular to the planar surface of the base plate.

Item 18. The mold of Item 3, wherein the plurality of first discrete regions are arranged in a pattern selected from the group consisting of a row, a column, a circle, a square, and a rectangle.

Item 19. The mold of any one of the above Items, wherein the first material comprises an inorganic material.

Item 20. The mold of any one of the above Items, wherein the first material comprises a metallic material.

Item 21. The mold of any one of the above Items, wherein the first material comprises a transition metal.

Item 22. The mold of any one of the above Items, wherein the first material comprises copper.

Item 23. The mold of any one of the above Items, wherein the second material comprises an organic material.

Item 24. The mold of any one of the above Items, wherein the second material comprises a polymer.

Item 25. The mold of any one of the above Items, wherein the second material comprises a resin.

Item 26. The mold of any one of the above Items, wherein the second material comprises an inorganic material.

Item 27. The mold of any one of the above Items, wherein the second material comprises a metallic material.

Item 28. The mold of any one of the above Items, wherein the second material comprises a ceramic material.

Item 29. The mold of any one of the above Items, wherein the second material comprises vitreous material.

Item 30. The mold of Item 4, wherein the first portion defines a first volume of the thickness of the base plate, and the second portion defines a second volume of the thickness of the base plate different than the first volume of the thickness of the base plate.

Item 31. The mold of Item 30, wherein the second volume is different than the first volume by at least about 5 vol %, at least about 10 vol %, at least about 15 vol %, at least about 20 vol %, at least about 25 vol %, at least about 30 vol %, at least about 40 vol %, at least about 50 vol %.

Item 32. The mold of Item 31, wherein the second volume is greater than the first volume.

Item 33. The mold of Item 31, wherein the second volume is less than the first volume.

Item 34. The mold of Item 4, wherein the first thermal conductivity is different than the second thermal conductivity by at least about 10%, at least about 20%, at least about 30%, at least about 40%, at least about 50%, at least about 60%, at least about 70%, at least about 80%, at least about 90%, at least about 95%, at least about 100%, at least about 150%, at least about 200%, at least about 350%, at least about 300%, at least about 350%, at least about 400%.

Item 35. The mold of Item 34, wherein the first thermal conductivity is greater than the second thermal conductivity.

Item 36. The mold of Item 34, wherein the first thermal conductivity is less than the second thermal conductivity.

Item 37. The mold of Item 14, wherein the surface includes a curved surface.

### Example 1

A slurry was prepared with water, one or more binder materials, and one or more dispersants. No pore formers were included in the slurry. The slurry was cast in a mold and processed according to a freeze-casting process to form a solid article. The mold included a base having a one or more discrete nucleation sites that occupied less than the entire surface area of a major surface of the base plate. The discrete nucleation sites were separated by a second material. The discrete nucleation sites had a thermal conductivity that was different than the thermal conductivity of the second material. The size of the discrete nucleation region was about 1 mm in diameter and the space between the adjacent discrete nucleation regions is about 10 mm. The resulting freeze-cast solid article was freeze-dried and sintered.

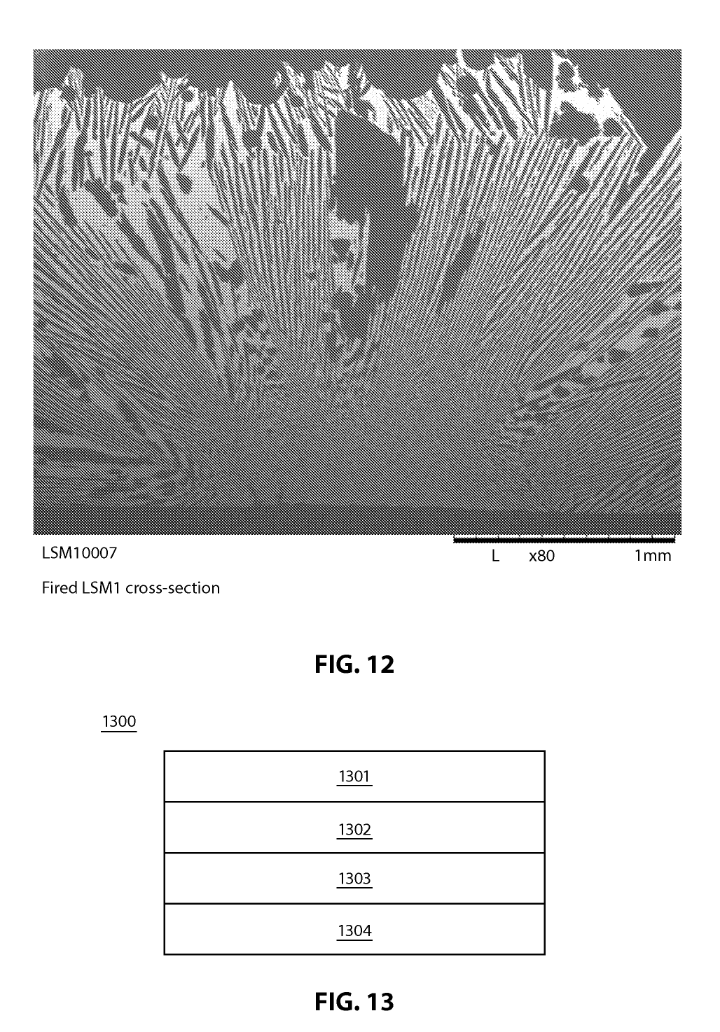

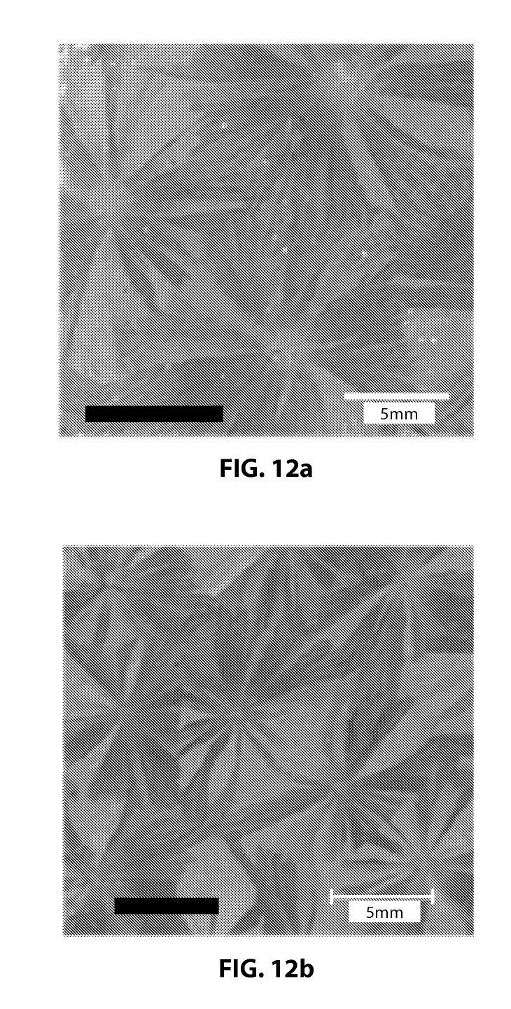

FIG. 12 is a side cross-sectional image of a portion of the solid article formed in accordance with this example. FIG. 12a is a bottom view image of a portion of the solid article formed in accordance with this example. As illustrated, and in accordance with embodiments described herein, a majority of the porosity channels can extend from the discrete nucleation region in a burst-like distribution.

### Example 2

Example 2 was prepared with water, one or more binder materials, and one or more dispersants. No pore formers were included in the slurry. The slurry was cast in a mold and processed according to a freeze-casting process to form a solid article. The mold included a base having a one or more discrete nucleation sites that occupied less than the entire surface area of a major surface of the base plate. The discrete nucleation sites were separated by a second material. The size of the discrete nucleation sites is about 0.5 mm in diameter and the space between adjacent discrete nucleation regions is about 5 mm. The discrete nucleation sites had a thermal conductivity that was different than the thermal conductivity of the second material. The resulting solid article was freeze-dried and sintered. FIG. 12 is a side cross-sectional image of a portion of the solid article formed in accordance with this example. FIG. 12b is a bottom view image of a portion of the solid article formed in accordance with this example. As illustrated, and in accordance with embodiments described herein, a majority of the porous channels can extend from the discrete nucleation region in a burst-like distribution.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. As used herein, the phrase “consists essentially of” or “consisting essentially of” means that the subject that the phrase describes does not include any other components that may substantially affect the property of the subject.

Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Further, reference to values stated in ranges includes each and every value within that range.

As used herein, the phrase “average particle diameter” can be reference to an average, mean, or median particle diameter, also commonly referred to in the art as D50.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the scintillation and radiation detection arts.

In the foregoing, reference to specific embodiments and the connections of certain components is illustrative. It will be appreciated that reference to components as being coupled or connected is intended to disclose either direct connection between said components or indirect connection through one or more intervening components as will be appreciated to carry out the methods as discussed herein. As such, the above-disclosed subject matter is to be considered illustrative, and not restrictive, and the appended claims are intended to cover all such modifications, enhancements, and other embodiments, which fall within the true scope of the present invention. Moreover, not all of the activities described above in the general description or the examples are required, that a portion of a specific activity may not be required, and that one or more further activities can be performed in addition to those described. Still further, the order in which activities are listed is not necessarily the order in which they are performed.

The disclosure is submitted with the understanding that it will not be used to interpret or limit the scope or meaning of the claims. In addition, in the foregoing disclosure, certain features that are, for clarity, described herein in the context of separate embodiments, can also be provided in combination in a single embodiment. Conversely, various features that are, for brevity, described in the context of a single embodiment, can also be provided separately or in any subcombination. Still, inventive subject matter may be directed to less than all features of any of the disclosed embodiments.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, or essential feature of any or all the claims.

Thus, to the maximum extent allowed by law, the scope of the present invention is to be determined by the broadest permissible interpretation of the following claims and their equivalents, and shall not be restricted or limited by the foregoing detailed description.

What is claimed is:

1. A mold for forming a porous article, comprising:
a base plate, comprising:
a first material and a second material, wherein the first material is at least partially embedded within the second material and configured to create regions of different thermal conductivity in the base plate.

2. The mold of claim 1, wherein at least one object extends at least partially through the base plate and configured to form a first discrete nucleation region within a material formed within the mold, wherein the at least one object includes a first material.

3. The mold of claim 1, wherein the base plate includes a plurality of first discrete regions spaced apart from each other, the plurality of first discrete regions comprising the first material, and wherein the plurality of first discrete regions are arranged in a predetermined distribution relative to each other.

4. The mold of claim 1, further comprising:
wherein the base plate includes a thickness;
wherein the first material includes a first thermal conductivity;
wherein the first material extends through a first portion of the thickness of the base plate;
wherein the second material includes a second thermal conductivity different from the first thermal conductivity; and
wherein the second material forms a second portion of the thickness of the base plate distinct from the first portion of the thickness of the base plate.

5. The mold of claim 2, wherein the base plate includes a surface, and wherein the thickness is defined in part by the surface.

6. The mold of claim 5, further comprising:
a first lateral member having a first interior lateral surface, the first lateral member attached to a first end of the base plate; and
a second lateral member having a second interior lateral surface, the second lateral member attached to a second end of the base plate.

7. The mold of claim 6, further comprising:
an interior surface defined in part by the surface of the base plate, the first interior lateral surface of the first lateral member, and the second interior lateral surface of the second lateral member.

8. The mold of claim 1, wherein the base plate further includes an exterior surface, and wherein the first material extends through a portion of the exterior surface of the base plate.

9. The mold of claim 7, wherein the first material extends through a portion of the interior surface of the mold.

10. The mold of claim 2, wherein the base plate includes the plurality of first discrete regions.

11. The mold of claim 1, wherein the base plate is integral with the mold.

12. The mold of claim 6, wherein the base plate is integral with the first and second lateral members.

13. The mold of claim 6, wherein the first and second lateral members are integral with each other.

14. The mold of claim 5, wherein the surface of the base plate is a planar surface, and wherein the first material is coplanar with the planar surface of the base plate.

15. The mold of claim 7, wherein the first material occupies less than an entire surface area of the interior surface of the mold.

16. The mold of claim 14, wherein the first and second lateral members are perpendicular to the planar surface of the base plate.

17. The mold of claim 3, wherein the plurality of first discrete regions are arranged in a pattern selected from the group consisting of a row, a column, a circle, a square, and a rectangle.

18. The mold of claim 1, wherein the first material comprises an inorganic material, a metallic material, a transitional metal, copper, or a combination thereof.

19. The mold of claim 1, wherein the second material comprises an organic material, a polymer, a resin, an inorganic material, a metallic material, a ceramic material, a vitreous material, or a combination thereof.

20. The mold of claim 4, wherein the first thermal conductivity is different than the second thermal conductivity by at least about 10%.
